(19) United States
(12) Patent Application Publication
(10) Pub. No.: US 2017/0300096 A1
(43) Pub. Date: Oct. 19, 2017

(54) ENERGY STORAGE SERVICING SYSTEMS AND METHODS

(71) Applicant: TANE MARTIN, Rancho Palos Verdes, CA (US)

(72) Inventor: TANE MARTIN, Rancho Palos Verdes, CA (US)

(21) Appl. No.: 15/186,010

(22) Filed: Jun. 17, 2016

Related U.S. Application Data
(63) Continuation-in-part of application No. 15/130,140, filed on Apr. 15, 2016.

(51) Int. Cl. G06F 1/26; G06F 1/28; G06F 1/30; G06F 11/30

(52) U.S. Cl. CPC G06F 1/266; G06F 11/3062; G06F 1/28; G06F 1/30

(57) ABSTRACT

A system and method for servicing an energy storage system includes a servicing office in communication with an energy storage system and capable of receiving a status from the energy storage system and dispatching a portable servicing facility to service the energy storage system. The energy storage system includes a service port and the portable servicing facility includes a corresponding servicing coupler. The portable servicing facility is capable of replacing depleted energy storage media from the energy storage system with charged energy storage media. The portable servicing facility can also update the energy storage system status in the servicing office after servicing the energy storage system.

### CROSS REFERENCE TO RELATED APPLICATIONS

This application is a continuation—in-part of and claims priority from U.S. patent application Ser. No. 15/130,140 filed on Apr. 15, 2016 and entitled “Flow Battery Servicing Systems and Methods,” which is incorporated herein by reference in its entirety for all purposes.

### FIELD OF THE DISCLOSURE

The present disclosure relates generally to batteries, and more particularly, to methods and systems for servicing and supporting battery systems.

### BACKGROUND

Electrical storage batteries are used to store electrical power for subsequent usage. There are many types of batteries. Examples include typical lead acid type batteries, dry cell batteries such as nickel-cadmium and lithium-ion cells and flow batteries. Each of the batteries can include one or more electrical storage cells. By way of example, a typical 12 volt automotive battery includes 6 cells electrically connected in series. Each of the 6 cells is approximately 2.0 volts and the series connected 6 cells form the nominal 12 volt automotive battery. In another example, a typical lithium ion battery is a 1.2 volt cell or combinations of 1.2 volt cells coupled in series to form higher voltage electrical storage battery. By way of example, fifty 1.2 volt lithium ion cells can be coupled in series to form a 60 volt battery. Multiple batteries and different types of batteries can be combined to provide the desired electrical storage capacity.

Flow batteries include a quantity of charged electrolyte stored in a reservoir. The charged electrolyte is flowed through the flow battery. As the charged electrolyte flows through the flow battery and the charged electrolyte transfers a portion of the charge to a second quantity of non-charged or depleted electrolyte. This charge transfer produces direct-current that can be utilized external from the flow battery similar to any other direct-current source.

Recharging the flow battery includes recharging the electrolyte stored in the reservoir. Electrolyte can be recharged by adding electrical power to the flow battery as the depleted electrolyte flows through the flow battery.

It is in this context that the following embodiments arise

### SUMMARY

Broadly speaking, the present disclosure fills these needs by providing a system and method for servicing, charging, and operating an energy storage system. It should be appreciated that the present disclosure can be implemented in numerous ways, including as a process, an apparatus, a system, computer readable media, or a device. Several inventive embodiments of the present disclosure are described below.

One embodiment provides a system for servicing a battery includes a servicing office in communication with a battery and capable of receiving a status from the battery and dispatching a portable servicing facility to service the battery. The battery includes a service port and the portable servicing facility includes a corresponding servicing coupler. The portable servicing facility is capable of replacing depleted electrical storage media from the battery with more charged electrical storage media. The portable servicing facility can also update the battery status in the servicing office after servicing the battery.

Another embodiment describes a battery including a first quantity of charged electrical storage media in a first reservoir where the first reservoir includes a first reservoir fill port and a first reservoir drain port and each of the first reservoir fill port and the first reservoir drain port are coupled to a servicing port having corresponding first drain ports and first fill ports. The servicing port can also include the communication port coupled to a battery controller and an electrical supply port. The electrical supply port can be used for bypassing the power provided by the battery while the battery is being serviced. The communication port enables a portable servicing facility to communicate with the battery controller during the servicing of the battery.

Another embodiment provides a method of servicing a battery in which a battery service request is received in a servicing office and the received request is analyzed to determine if the battery services are needed. If the battery services are needed then the battery service automatically generates and issues a dispatch order to a servicing facility to direct the servicing facility to service the corresponding battery. When the servicing facility arrives at the site of the battery, the servicing facility can connect a servicing coupler to a servicing port of the battery and service the battery. Servicing the battery can include replacing quantities of one or more quantities of electrical storage media and/or identifying failed parts and repairing or replacing those failed parts of the battery, communicating with the battery controller during the servicing and providing a bypass power source during the battery servicing as the battery is deactivated during the servicing.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The present disclosure will be readily understood by the following detailed description in conjunction with the accompanying drawings.

FIG. 1 is a simplified schematic diagram of a flow battery storage and servicing system, for implementing embodiments of the present disclosure.

FIG. 2A is a simplified schematic diagram of the flow battery, for implementing embodiments of the present disclosure.

FIG. 2B is a simplified schematic diagram of an alternative flow battery, for implementing embodiments of the present disclosure.

FIG. 3A is a simplified schematic of a front view of the service port, for implementing embodiments of the present disclosure.

FIG. 3B is a simplified schematic of a front view of the servicing coupler, for implementing embodiments of the present disclosure.

FIG. 3C is a simplified schematic of a side view of the service port and the servicing coupler, for implementing embodiments of the present disclosure.

FIG. 4 is a flowchart diagram that illustrates the method operations performed in servicing a flow battery, for implementing embodiments of the present disclosure.

FIG. 5A is a simplified schematic diagram of a support facility for the servicing facility, for implementing embodiments of the present disclosure.

FIG. 5B is a flowchart diagram that illustrates the method operations performed in offloading, storing and loading the electrolytes, for implementing embodiments of the present disclosure.

FIG. 5C is a flowchart diagram that illustrates the method operations performed in recharging the depleted electrolytes, for implementing embodiments of the present disclosure.

FIG. 6 is simplified block diagram of the flow battery services system, for implementing embodiments of the present disclosure.

FIG. 7 is a flowchart diagram that illustrates the method operations performed in processing and accessing a subscriber account for servicing a flow battery, for implementing embodiments of the present disclosure.

FIG. 8A is a flowchart diagram that illustrates the method operations performed in processing and accessing a subscriber account for servicing a flow battery, for implementing embodiments of the present disclosure.

FIG. 8B is a flowchart diagram that illustrates the method operations performed in processing a service request for servicing a flow battery, for implementing embodiments of the present disclosure.

FIG. 9 is a flowchart diagram that illustrates the method operations performed in processing a received flow battery status, for implementing embodiments of the present disclosure.

FIG. 10 is a block diagram of an example computer system 1000, for implementing embodiments of the present disclosure.

FIG. 11 is a simplified block diagram of an energy storage system, for implementing embodiments of the present disclosure.

FIG. 12A is simplified block diagram of an energy storage system, using multiple flex cells, for implementing embodiments of the present disclosure.

FIG. 12B is a simplified block diagram of an energy storage system, using multiple flex cells, for implementing embodiments of the present disclosure.

FIG. 13 is a simplified block diagram of a flex cell configured for use in the energy storage system, for implementing embodiments of the present disclosure.

FIG. 14 is a flowchart diagram that illustrates the method operations performed in operating the energy storage system with multiple flex cells, for implementing embodiments of the present disclosure.

FIG. 15 is a flowchart diagram that illustrates the method operations performed in servicing the energy storage system with multiple flex cells, for implementing embodiments of the present disclosure.

### DETAILED DESCRIPTION

Several exemplary embodiments for servicing, charging, and operating an energy storage system will now be described. It will be apparent to those skilled in the art that the present disclosure may be practiced without some or all of the specific details set forth herein.

There many different types of electrical storage batteries. Each type of battery has a corresponding electrical storage media. In a typical lead acid cell the electrical storage media is the chemical reaction of the acid and lead. Similarly, in a lithium-ion cell, the electrical storage media is the chemical reaction between the lithium and the ion source. In a larger view, the electrical storage media in a battery system, can include complete electrical storage cells. For example, in many industrial applications of large battery systems, there are many separate electrical storage cells that can be removed and replaced individually. Thus in a larger view, each of the separate electrical storage cells can be considered a portion of the electrical storage media in the battery system.

A flow battery is a type of rechargeable battery where rechargeability is provided by two chemical components, usually dissolved in liquids and typically referred to as electrolytes. The electrolytes are contained in one or more tanks, for each of the electrolytes, within the flow battery system. The flow battery includes a reaction chamber that is typically, but not always, separated by a membrane. As the electrolytes flow into the reaction chamber, an ion exchange provides a flow of electric current and occurs through the membrane while the electrolytes circulate in their respective spaces. Flow batteries often include multiple cells connected in series within the reaction chamber to produce the desired voltage. Each cell of the flow battery typically produces from about 1.0 to 2.2 volts.

Flow batteries have technical advantages such as potentially separable and refillable electrolyte tanks and near unlimited longevity over most conventional rechargeable battery types. The energy capacity of the flow battery is a function of the electrolyte volume and the power to the surface area of the electrodes in the reaction chamber.

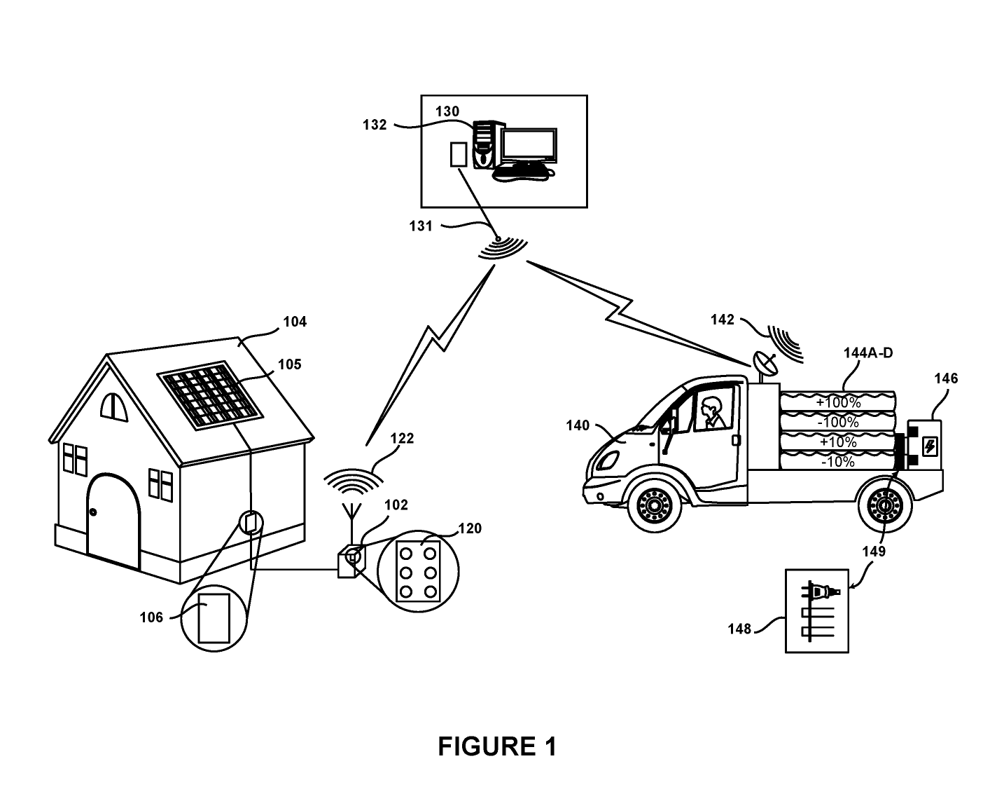

FIG. 1 is a simplified schematic diagram of a flow battery storage and servicing system 100, for implementing embodiments of the present disclosure. The flow battery storage and servicing system 100 includes a flow battery 102 that is coupled to a load 104. In this instance, the load 104 is a house, but load could be any type of electrical load.

The load 104 can include additional power sources such as a solar panel 105 or a connection to a power grid (not shown) or other external electrical power sources such as a generator (not shown) for providing at least a portion of the power consumed by the load. The solar panel 105 can also be coupled to a recharging device 106 that is also coupled to the flow battery 102. The recharging device 106 can recharge the flow battery 102. In one implementation, the recharging device can include an inverter capable of converting the DC power from the solar panels and/or the flow battery to AC power for the load. In another implementation, the recharging device can include a DC or an AC power device capable of recharging one or more of the electrolytes in the flow battery. In another implementation, the recharging device can include a DC power device for powering the load with DC power.

The flow battery 102 includes a servicing port 120. The servicing port 120 allows the flow battery 102 to be serviced such as replacing the electrolyte in the flow battery, as will be described in more detail below.

In one implementation, the flow battery 102 also includes a communication device 122. The communication device 122 could be wired or wireless. The communication device 122 can communicate a status of the flow battery 102 to a servicing office 130 via a servicing office communication link 131. The communication device 122 can also receive communications from the servicing office 130. By way of example, the servicing office 130 can perform diagnostics and control functions of the flow battery 102 via the servicing office communication link 131. The servicing office 130 can include one or more servicing computers 132 capable of receiving the status communications from the flow battery 102 and storing the flow battery status communications in a suitable data storage. The servicing computers 132 can also compare an account setting corresponding to the flow battery 102 to determine whether the flow battery requires service. If the flow battery 102 requires service, the servicing computers 132 can issue a servicing order to one or more portable servicing facilities 140 such as a truck or other capabilities for servicing the flow battery.

The servicing facility 140 can include one or more tanks 144A-D for storing and transporting the electrolyte. The servicing facility 140 can also include a servicing facility communication link 142 for communicating with the servicing office 130. The servicing facility 140 can also include a standby power source 146 such as a generator or a battery pack or other suitable power source. The servicing facility 140 can also include a servicing coupler 148 for coupling the servicing facility to the servicing port 120 of the flow battery 102. Servicing coupler 148 can be coupled to the servicing facility 140 via one or more hoses and/or cables 149, as will be described in more detail below. In one implementation, the servicing facility communication link 142 is capable of communicating directly with the flow battery's communication device 122. The communication between the servicing facility 140 and the flow battery allows the servicing facility to contact the flow battery and determine if the flow battery needs to be serviced such as based on a discharge state of the flow battery. By way of example, the servicing facility can contact flow batteries and if a flow battery has a discharge state below a preselected level, e.g., less than 20 percent charge remaining, then the servicing facility can service the flow battery as described in more detail below.

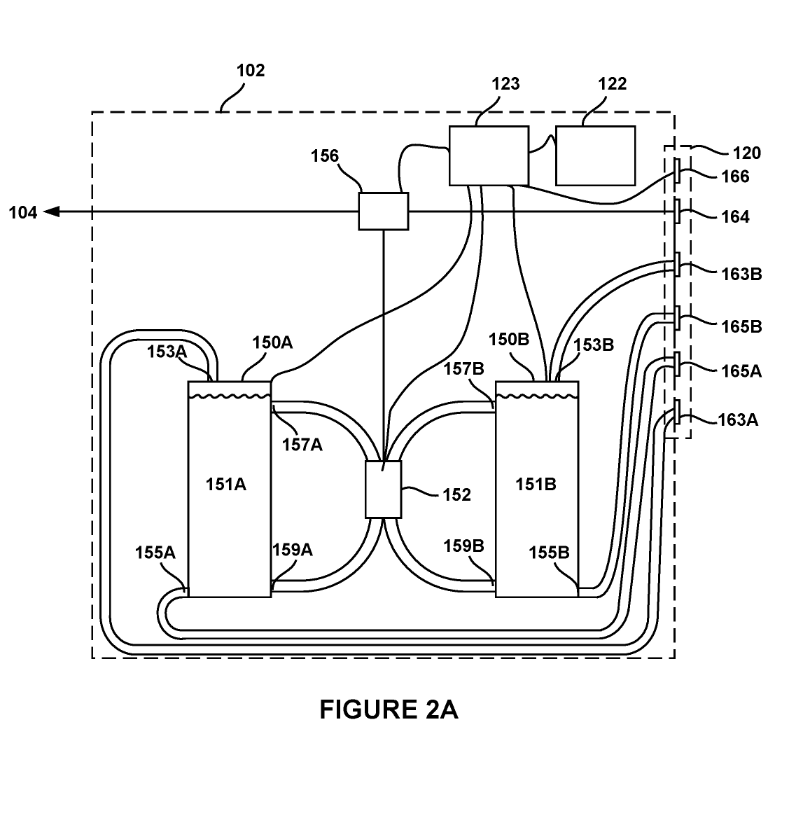

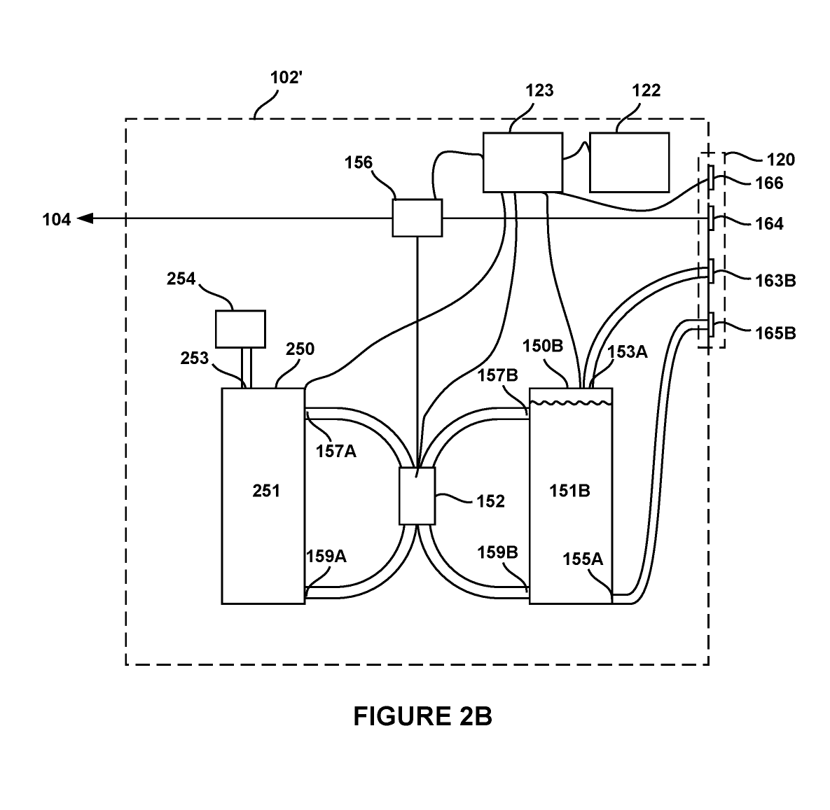

FIG. 2A is a simplified schematic diagram of the flow battery 102, for implementing embodiments of the present disclosure. The flow battery 102 includes a controller 123 and the communications device 122. The flow battery 102 also includes a first reservoir 150A and a second reservoir 150B. The first reservoir 150A contains a quantity 151A of positive electrolyte. The first reservoir 150A is coupled to a reaction chamber 152 through first output port 157A and from the reaction chamber to the first return port 159A. The second reservoir 150B contains a quantity 151B of negative electrolyte. The second reservoir 150B is coupled to the reaction chamber 152 through second output port 157B and from the reaction chamber to the second return port 159B. A first drain port 155A and a first fill port 153A of the first reservoir 150A are coupled to the servicing port 120 at respective drain port 165A and fill port 163A. Similarly, second drain port 155B and a second fill port 153B of the second reservoir 150B are coupled to the servicing port 120 at respective drain port 165B and fill port 163B.

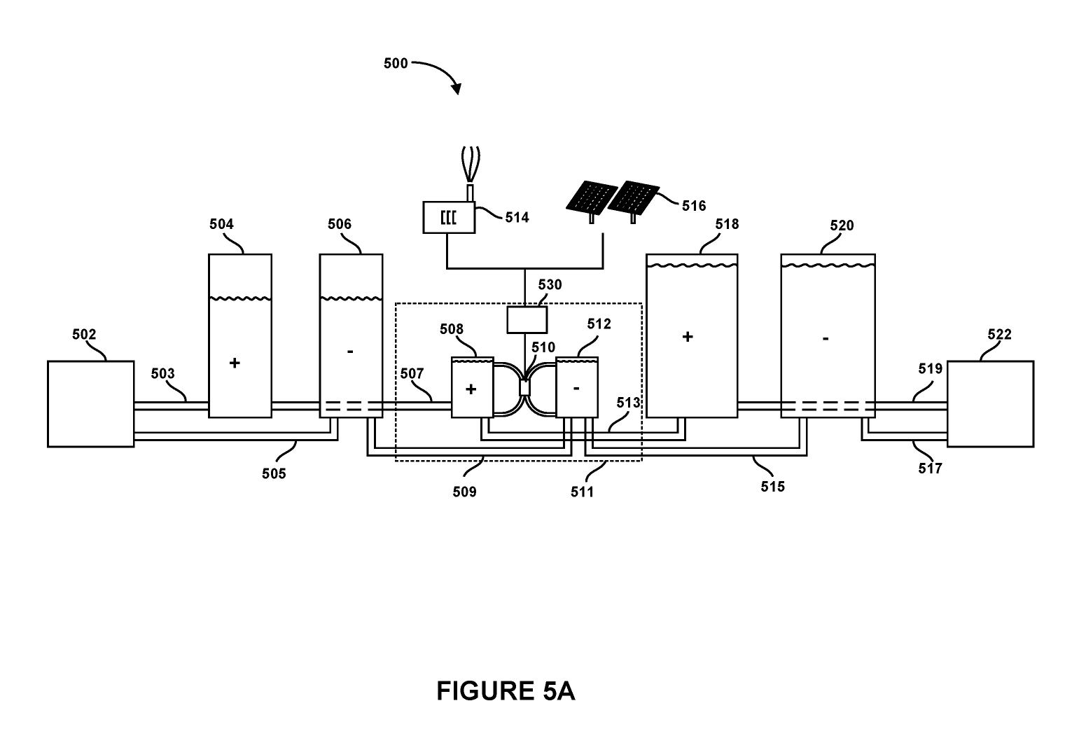

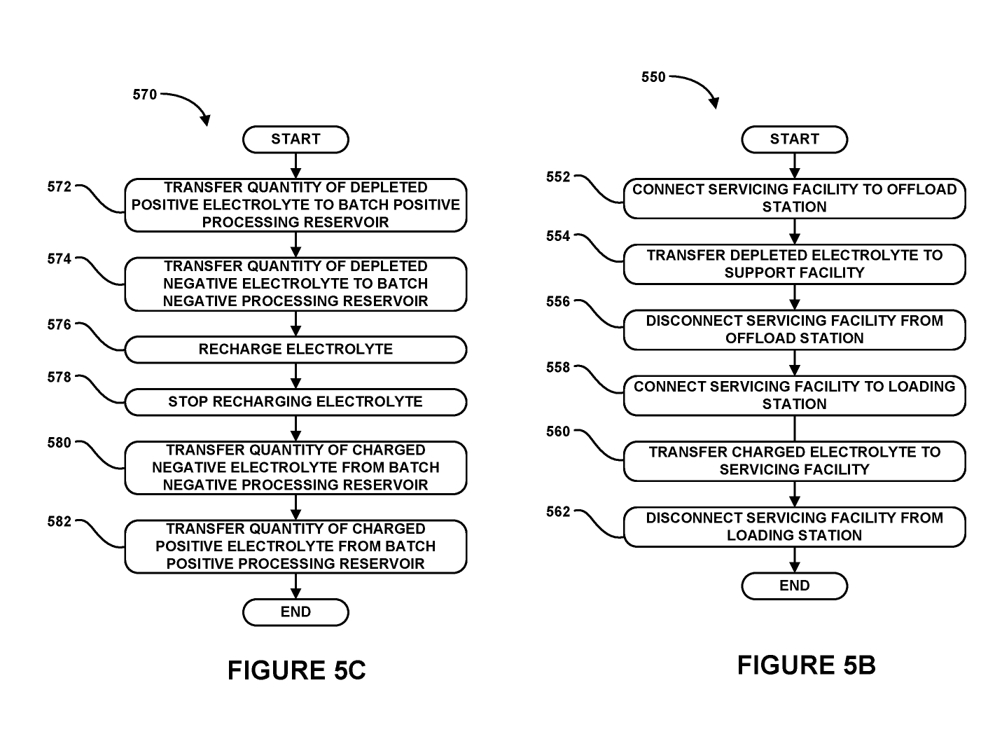

The flow battery 102 also includes an electrical load control device 156. Electrical load control device 156 couples the electrical power produced by the flow battery 102 in the reaction chamber 152 to the load 104. Electrical load control device 156 can also couple power from additional sources other than the reaction chamber 152 to support the electrical load 104. In one implementation, the electrical load control device 156 can utilize an external electrical power source coupled through the electrical power supply port 164 of the servicing port 120. In another implementation, electrical load control device 156 can utilize power provided from the recharging device 106 and/or from the external electrical power source coupled through the electrical power supply port 164 to at least partially recharge the electrolyte 151A, 151B stored in one or both of the reservoirs 150A, 150B in a similar manner to recharging the electrolyte as described in FIG. 5A below.

The controller 123 is coupled to each of the electrical load control device 156, the communication device 122, a communication port 166 of the servicing port 120, each of the reservoirs 150A, 150B and the reaction chamber 152 for monitoring and controlling the operation of the flow battery 102. The controller 123 can also include software for monitoring and controlling the operation of the flow battery 102. The software can also include firmware or hardware coding.

The flow battery 102 can also include additional elements not shown in the figures. In one or more implementations, the flow battery 102 can include one or more valves, one or more pumps, one or more flowmeters and/or flow controllers for controlling flow of the electrolyte 151A, 151B into and out of the reservoirs 150A, 150B. Any of the valves described herein can include manual mechanical valves requiring manual operation and/or electro or pneumatically operated valves capable of being controlled by the controller 123.

In one or more implementations, the flow battery 102 can also include additional sensors for the controller 123 to monitor the operation of the flow battery. The sensors can include temperature sensors for monitoring temperatures of various components of the flow battery 102. Other sensors can include charge sensors for monitoring a present charge status of the positive electrolyte 151A and negative electrolyte 151B. Voltage and current sensors can be included for monitoring the power produced by the flow battery 102. Other sensors that could be included can include quantity sensors for monitoring a quantity of the electrolytes 151A, 151B in the reservoirs 150A, 150B. The quantity sensors can monitor a volume, a pressure or a weight or other quantity aspects that can be measured.

While not shown in FIG. 2A, it should be understood that each of the reservoirs 150A, 150B can include more than one reservoir. By way of example, the first reservoir 150A can include two reservoirs including a first supply reservoir and a first storage reservoir. Where the first supply reservoir stores the electrolyte before passing the electrolyte through the reaction chamber 152 and the first storage reservoir stores the electrolyte after passing electrolyte through the reaction chamber. Similarly, the second reservoir 105B can include a second supply reservoir and a second storage reservoir. It should also be understood that the reservoirs 150A, 150B may physically be a single reservoir that is partitioned so that internally the reservoirs include more than one storage volume for storing the electrolytes 151A, 151B.

It should also be noted that the reservoirs 150A, 150B can be located within the flow battery 102 or externally from the flow battery. By way of example, the reservoirs 150A, 150B can be located externally from the flow battery 102 such as positioned above the flow battery, so as to allow gravity to provide the motive force for flowing the electrolytes 151A, 151B through the reaction chamber 152. In another implementation with multiple reservoirs, a first supply reservoir and a second supply reservoir can be located above the reaction chamber 152, so that gravity can provide the motive force for flowing the electrolytes 151A, 151B through the reaction chamber and a first storage reservoir and a second storage reservoir are located below the reaction chamber so that the electrolyte can flow from the reaction chamber to the first storage reservoir and the second storage reservoir using gravity as the motive force.

FIG. 2B is a simplified schematic diagram of an alternative flow battery 102′, for implementing embodiments of the present disclosure. The alternative flow battery 102′ uses a single fluid electrolyte 151B and air 251. In one implementation, the air 251 is delivered directly to the reaction chamber 152. In another implementation a pressurized air source 254 provides a quantity of air to an inlet 253 of an air reservoir 250. The pressurized air source 254 can be a pump or a storage tank of pressurized air. It should be understood that while air is described, any suitable combination of one or more gases found in the atmosphere can be used. In one implementation the pressurized air source 254 can include a liquefied gas source and an evaporator to convert the liquefied gas to a gaseous state.

It should be understood that even though the service port 120 is shown in FIG. 2A and 2B as being part of the flow battery 102, 102′, the service port can be remote from the flow battery. In one implementation, the service port 120 can be a significant distance separated away from the flow battery 102, 102′ and coupled to the flow battery via corresponding hoses, pipes, wiring. By way of example, the flow battery 102, 102′ can be located close to the load 104 and the service port can be located near a street or road access so that the servicing facility 140 does not need to directly access the location of the flow battery.

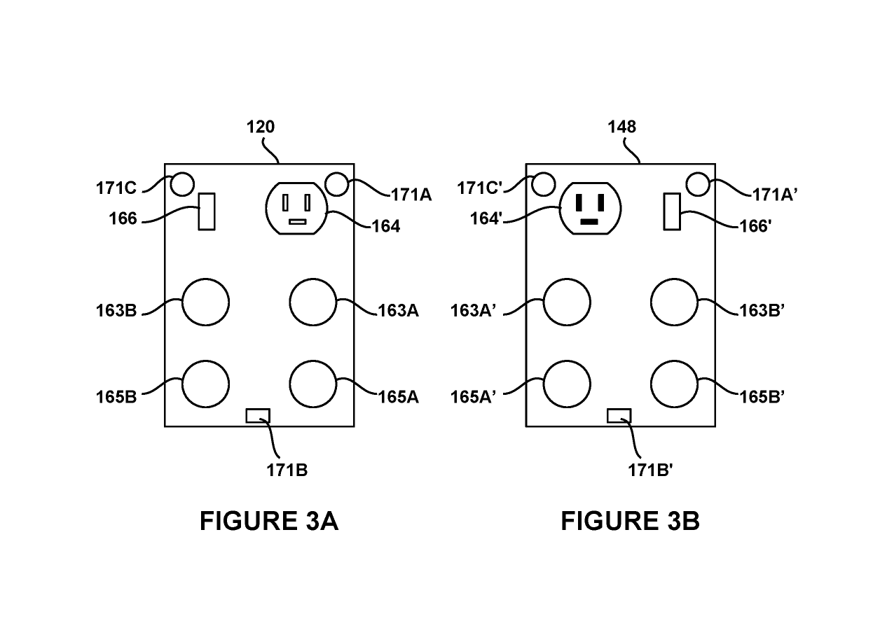

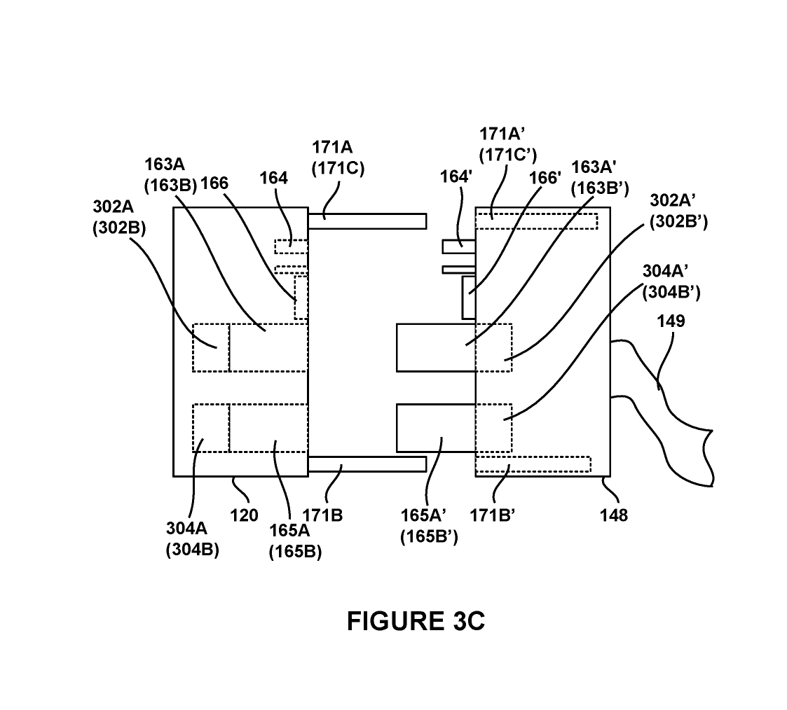

FIG. 3A is a simplified schematic of a front view of the service port 120, for implementing embodiments of the present disclosure. The service port 120 includes the communication port 166, the electrical supply port 164, drain port 165A and fill port 163A for the first reservoir 150A and drain port 165B and fill port 163B for the second reservoir 150B. The communication port 166 provides communications access to the controller 123 by the servicing facility 140 during service of the flow battery 102.

FIG. 3B is a simplified schematic of a front view of the servicing coupler 148, for implementing embodiments of the present disclosure. The servicing coupler 148 corresponds to and couples to the service port 120. The servicing coupler 148 includes a servicing communication port 166′ corresponding to and for connecting to the communication port 166, and electrical supply connector 164′ corresponding to and for connecting to the electrical supply port 164, a drain port connector 165A′ corresponding to and for connecting to the drain port 165A, a fill port connector 163A′ corresponding to and for connecting to the fill port 163A for the first reservoir 150A and a drain port connector 165B′ corresponding to and for connecting to the drain port 165B and a fill port connector 163B′ corresponding to and for connecting to the fill port 163B for the second reservoir 150B.

FIG. 3C is a simplified schematic of a side view of the service port 120 and the servicing coupler 148, for implementing embodiments of the present disclosure. As the service port 120 and the servicing coupler 148 are moved toward each other the corresponding connectors align and engage. Several elements are not shown as they are hidden in the side view and are called out in parentheses for completeness. In one implementation, the service port 120 includes alignment pins 171A, 171B and 171C (hidden in side view) and the servicing coupler 148 includes corresponding alignment slots 171A′, 171B′ and 171C′ that correspond to and connect to the alignment pins in the service port. The alignment pins in the alignment slots ensure that the connections are all aligned to provide a positive secure connection between the servicing coupler 148 and the service port 120.

In one implementation, the alignment slots 171A′, 171B′ and 171C′ and the corresponding alignment pins 171A, 171B and 171C can be located in different positions on each of the service port 120 and the servicing coupler 148 to provide a clocking orientation, as shown in FIGS. 3A and 3B. In one implementation, the alignment slots 171A′, 171B′ and 171C′ and the corresponding alignment pins 171A, 171B and 171C can have specific shapes to provide a more precise alignment, as shown in FIGS. 3A and 3B. It should be understood that the alignment pins in slots and/or the arrangement of the different connectors in the servicing port and the servicing coupler provide alignment structures that can be implemented in any one or more of many different ways so as to provide a corresponding alignment and secure coupling between the servicing port and the servicing coupler.

In at least one implementation, at least one of the service port 120 and the servicing coupler 148 can include valves 302A, 302B, 304A, 304B and/or 302A′, 302B′, 304A′, 304B′ that can prevent the flow of the electrolytes 151A, 151B until the service port and the servicing coupler are fully engaged. It should be noted that valves 302B, 304B, 302B′and 304B′ are hidden in the side view. These valves can be manually or automatically activated or the valves can be activated by contact of the fill port connectors with their respective fill ports. In one implementation, one or more of the alignment pins can activate one or more of the valves when the alignment pins are fully engaged with the respective alignment slots.

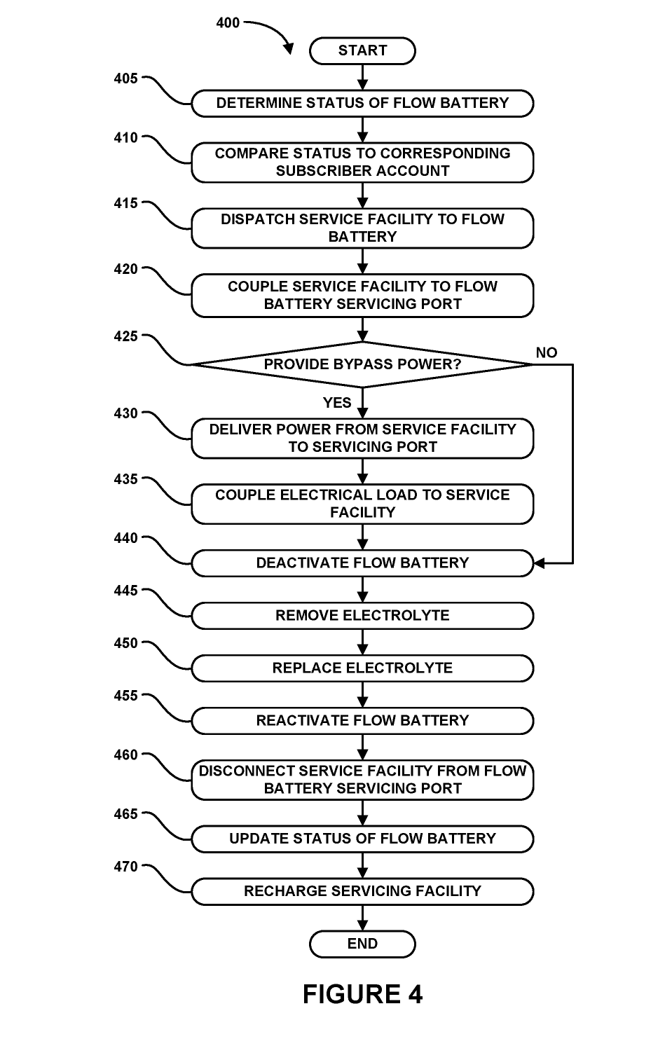

FIG. 4 is a flowchart diagram that illustrates the method operations performed in servicing a flow battery 400, for implementing embodiments of the present disclosure. The operations illustrated herein are by way of example, as it should be understood that some operations may have sub-operations and in other instances, certain operations described herein may not be included in the illustrated operations. With this in mind, the method and operations 400 will now be described.

In operation 405, the status of the flow battery 102 is determined in the servicing office 130. Status of the flow battery 102 can be determined in numerous ways. The status of the flow battery 102 can optionally include an identifier assigned to the flow battery. In one implementation the status of the flow battery 102 is determined by a manual notification by user of the flow battery. In another implementation, the status of the flow battery 102 is determined by a setting or other notification provided by the controller 123 of the flow battery via the communications device 122 that communicates the corresponding status of the flow battery to the servicing office 130 automatically. The flow battery status can include one or more of a current and/or past state of many aspects of the flow battery. By way of example, the flow battery status can include a current charge state, a current depleted state, a quantity of one or more of the electrolytes, temperatures of one or more portions of the flow battery, a time since the flow battery was last serviced, identifier of who performed the last service, a peak, a minimum and/or an average power produced by the flow battery for a given operational period, operational time, a unique identifier for the flow battery, a location of the flow battery, a serial number of the flow battery, a model number of the flow battery and many other aspects of the flow battery.

In one implementation, the status of the flow battery 102 can be updated with the servicing office 130 only when a particular event occurs. By way of example when the flow battery is in need of a service such as a specific discharge state of the flow battery has been reached. In another implementation, the status of the flow battery 102 can be updated in the servicing office 130 on a periodic basis. By way of example, the status of the flow battery 102 can be updated in the servicing office 130 every hour of each day or once per day or however often may be desired. In another implementation, the status of the flow battery 102 can be determined by a query sent from the servicing office 130 the flow battery and the flow battery responds to the query. It should also be understood that the status of the flow battery 102 can include combinations of one or more of the above described example implementations.

In an operation 410, received status of the flow battery 102 is compared to a corresponding subscriber account by the servicing computers 132. Comparing the corresponding subscriber account can include querying a database of subscriber accounts, identifying the subscriber account corresponding to the flow battery identifier corresponding to the flow battery 102. The subscriber account can include subscriber settings. The subscriber settings can include various options for the subscriber such as subscriber identification information, subscriber contact information, location of the flow battery 102, how often the subscriber wishes the flow battery to be serviced, subscriber billing information and any special instructions regarding servicing the flow battery. In one implementation, the subscriber settings can include a typical discharge power utilized by the load 104. The typical discharge power utilized by the load 104 can be used to determine a length of time before the flow battery 102 must be recharged before the flow battery is fully depleted. Another subscriber setting can be a charge power and/or expected charge power generated by the generator (or solar panels). It should be understood that in one or more implementations, one or more of the subscriber settings can be dynamic and be automatically updated according to a current demand situation or recent flow battery operational history. Special instructions, for example, could include information for locating and accessing the service port 120 and whether or not the servicing facility should support the electrical load during the servicing of the flow battery 102.

By way of example, if in operation 405, the flow battery status was at 60 percent charge, and the subscriber settings indicated servicing only when the low battery status is less than 40 percent charge, then in operation 410, it would be determined that the flow battery 102 should not be serviced.

In another example, if in operation 405, the flow battery status was at 60 percent charge, and the last time the flow battery 102 was serviced was one month ago, and the subscriber settings indicated that servicing should occur at least once per month, then the flow battery is due for service.

In another example, if in operation 405, the flow battery status indicates that the flow battery 102 is off-line, such as due to some sort of failure of the flow battery or a failure to communicate with the servicing office 130, then the servicing office may determine that the flow battery is due for immediate service.

In an operation 415, when the flow battery 102 is determined to be due for service in operation 410, then dispatch instructions are sent to a servicing facility 140 to dispatch the service facility to the flow battery. The servicing facility 140 can include a repair facility and/or a recharge facility and combinations thereof. In an operation 420, the servicing facility 140 arrives at the site of the flow battery 102 and couples the servicing coupler 148 to the service port 120 of the flow battery.

In an operation 425, the dispatch instructions received by the servicing facility 140 are reviewed to determine whether or not the service facility is to provide bypass electrical power to the electrical load 104 during the servicing of the flow battery 102. In one implementation, the dispatch instructions are received electronically and a controller on the servicing facility 140 automatically executes these electrical power bypass instructions when the servicing coupler 148 is connected to the service port 120 in operations 430 and 435 to deliver power to the flow battery from the servicing facility and to bypass the power supplied by the operations of the flow battery to the load so that the servicing facility is providing power to the load. If the dispatch instructions do not include the servicing facility 140 providing electrical power to the electrical load during servicing of the flow battery 102, and the method operations skip operations 430 and 435 to an operation 440, as described below. In one implementation, connecting the servicing coupler 148 to the service port 120 can automatically bypass electrical power from the flow battery 102 and deliver electrical power from the standby power source 146 to the electrical load 104.

In operation 440, the operation of the flow battery 102 is deactivated. The operation of the flow battery 102 can be deactivated by stopping the flow of the electrolytes 151A, 151B from the respective reservoirs 150A into the reaction chamber 152. Deactivating the operation of the flow battery 102 can also include disabling the operations of the reaction chamber 152 such as removing the electrolytes 151A, 151B from the reaction chamber and/or removing the membrane from the reaction chamber and/or other method of isolating the electrolytes from reacting in the reaction chamber.

In an operation 445, at least a portion of one or more of each of the electrolytes 151A, 151B in one or more of the reservoirs 150A, 150B is withdrawn from the respective reservoirs, and stored in one or more tanks 144A-D of the servicing facility 140. By way of example, tank 144C can include depleted positive electrolyte 151A, and thus depleted positive electrolyte 151A that is withdrawn from reservoir 150A would be stored in the tank 144C. Similarly, tank 144D can include depleted negative electrolyte 151B, and thus depleted negative electrolyte 151B that is withdrawn from reservoir 150B would be stored in the tank 144D.

In an operation 450, the removed portion(s) of the electrolytes 151A, 151B in one or more of the reservoirs 150A, 150B is replaced in the respective reservoirs with charged electrolyte from one or more tanks 144A-D of the servicing facility 140. By way of example, tank 144A can include charged positive electrolyte 151A+, and thus the depleted electrolyte 151A that was withdrawn from reservoir 150A would be replaced with charged positive electrolyte 151A+ from the tank 144A. Similarly, tank 144B can include charged negative electrolyte 151B−, and thus the depleted negative electrolyte 151B that was withdrawn from reservoir 150B would be replaced with charged negative electrolyte 151B− from the tank 144B.

In an operation 455, the flow battery 102 is reactivated. The flow battery 102 can be reactivated by the controller 123 restarting the flow of the electrolytes 151A, 151B from the respective reservoirs 150A into the reaction chamber 152. Reactivating the flow battery 102 can also include transferring the electrical load 104 from the servicing facility 140 to the flow battery via the electrical load control device 156.

In an operation 460, the servicing facility 140 is disconnected from the service port 120. Disconnecting the servicing facility 140 from the service port 120 can also include reactivating the flow battery 102 and transferring the electrical load 104.

In an operation 465, the status of the flow battery 102 is updated with the servicing office 130. The servicing office 130 updates the status of the flow battery 102 in the corresponding subscriber account information. The status of the flow battery 102 can be updated by the controller 123 via the communications device 122 and/or by the servicing facility 140 via the servicing facility communication link 142.

In at least one implementation, in an operation 470, the servicing facility 140 departs the site of the flow battery 102 and is returned to a support facility 500, as will be described in more detail below, and the method operations can end.

FIG. 5A is a simplified schematic diagram of a support facility 500 for the servicing facility 140, for implementing embodiments of the present disclosure. The support facility 500 includes an offloading station 502, a depleted positive electrolyte storage tank 504, a depleted negative electrolyte storage tank 506, a batch processing recharge facility 511, a charged positive electrolyte tank 518, a charged negative electrolyte tank 520 and a loading station 522. The offloading station 502 is coupled to the depleted positive electrolyte storage tank 504 and the depleted negative electrolyte storage tank 506 by respective pipelines 503 and 505. The depleted positive electrolyte storage tank 504 is coupled to the batch processing recharge facility 511 by pipeline 507. The depleted negative electrolyte storage tank 506 is coupled to the batch processing recharge facility 511 by pipeline 509.

The loading station 522 is coupled to the charged negative electrolyte storage tank 520 and the charged positive electrolyte storage tank 518 by respective pipelines 517 and 519. The charged negative electrolyte storage tank 520 is coupled to the batch processing recharge facility 511 by pipeline 515. The charged positive electrolyte storage tank 518 is coupled to the batch processing recharge facility 511 by pipeline 513.

In one implementation, the batch processing recharge facility 511 includes a flow battery formed by a batch processing positive reservoir 508, a reaction chamber 510, a batch processing negative reservoir 512 and at least one power source 514, 516. The power sources can include a generator or other conventional power source such as the power grid 514 and/or one or more alternative power sources such as a photovoltaic solar panel array 516. It should be understood that these are just exemplary power sources and any suitable power source could be used.

FIG. 5B is a flowchart diagram that illustrates the method operations 550 performed in offloading, storing and loading the electrolytes 151A, 151B, for implementing embodiments of the present disclosure. The operations illustrated herein are by way of example, as it should be understood that some operations may have sub-operations and in other instances, certain operations described herein may not be included in the illustrated operations. With this in mind, the method and operations 550 will now be described.

In an operation 552, the servicing facility 140 arrives at the support facility 500 to offload the depleted electrolytes 151A, 151B. In one implementation, the servicing facility is coupled to the offloading station 502 via the servicing coupler 148. However, it should be understood that other methods of coupling the servicing facility 140 to the offloading station 502 could be used. For example, a larger diameter hose or pipe could be used to connect the servicing facility 140 to the offloading station 502 to speed the flow of the depleted electrolytes 151A, 151B from the servicing facility.

In an operation 554, the depleted electrolytes 151A, 151B are transferred from the servicing facility 140 to the respective tanks 504, 506. The servicing facility 140 can disconnect from the offloading station 502 once the depleted electrolytes 151A, 151B are transferred from the servicing facility 140 to the respective tanks 504, 506, in an operation by 556. Transferring the electrolytes 151A, 151B from the servicing facility 140 to the respective tanks 504, 506 can also include a testing process for testing the electrolytes being transferred from the servicing facility to determine the quality of the electrolytes being transferred. By way of example, the transferred electrolytes can be tested for contaminants, charge/depleted states and many other aspects of the electrolytes. Once the electrolytes are tested, the electrolytes may undergo additional processes before completing the transfer to the support facility 500.

In an operation 558, the servicing facility 140 is coupled to the loading station 522. In one implementation, the servicing facility is coupled to the loading station 522 via the servicing coupler 148. However, it should be understood that other methods of coupling the servicing facility 140 to the loading station 522 could be used. For example, a larger diameter hose or pipe could be used to connect the servicing facility 140 to the loading station 522 to speed the flow of the charged electrolytes 151A+, 151B− from the respective tanks 518, 520.

In an operation 560, the charged electrolytes 151A+, 151B− are transferred from the respective tanks 518, 520 to the servicing facility 140. The servicing facility 140 can disconnect from the loading station 522 once the charged electrolytes 151A+, 151B− are transferred from the respective tanks 518, 520 to the servicing facility 140, in an operation by 562 and the method operations can end.

In one implementation, the servicing facility 140 can be coupled to the unloading station 502 and the loading station 522 substantially simultaneously, e.g., operations 552 and 558 can occur substantially simultaneously.

Similarly, if the servicing facility 140 has four or more tanks, e.g., tanks 144A-D, with respective tanks for charged and depleted electrolytes 151A, 151A+, 151B and 151B−, then the depleted electrolytes can be offloaded from the servicing facility, at substantially the same time that the charged electrolytes are loaded onto the servicing facility, e.g., operations 554 and 560 can occur substantially simultaneously.

FIG. 5C is a flowchart diagram that illustrates the method operations 570 performed in recharging the depleted electrolytes 151A, 151B, for implementing embodiments of the present disclosure. The operations illustrated herein are by way of example, as it should be understood that some operations may have sub-operations and in other instances, certain operations described herein may not be included in the illustrated operations. With this in mind, the method and operations 570 will now be described.

In an operation 572, a first quantity of depleted positive electrolyte 151A is transferred from the depleted positive electrolyte storage tank 504 to the batch processing positive reservoir 508.

In an operation 574, a first quantity of depleted negative electrolyte 151B is transferred from the depleted negative electrolyte storage tank 506 to the batch processing negative reservoir 512.

In an operation 576, an electrolyte recharging process is begun. Electrolyte recharging process includes flowing the depleted positive electrolyte 151A and the depleted negative electrolyte 151B into the reaction chamber 510 while an electrical charge is applied to the reaction chamber 510 to recharge the positive and negative electrolytes. The recharging of the electrolytes continues until the electrolytes stored in the batch processing positive reservoir 508 and batch processing negative reservoir 512 are fully recharged to a preselected level. The controller 530 manages and monitors the recharging process. The controller 530 can also include a support facility communication device for communicating with the servicing office 130 via the servicing office communication link 131. The controller 530 can use the support facility communication device for coordinating operations with and receiving instructions and updating support facility operations data with the servicing office 130. In one implementation, the support facility operations data can include data received from the servicing facility 140 regarding the electrolyte received from and loaded onto the servicing facility and electrolyte recharging quantities, energy usage and any other support facility operations data. In an operation 578, the electrolyte recharging process is stopped.

In an operation 580, a first quantity of charged negative electrolyte 151B− is transferred from the batch processing negative reservoir 512 to the charged negative electrolyte storage tank 520.

In an operation 582, a first quantity of charged positive electrolyte 151A+ is transferred from the batch processing positive reservoir 508 to the charged positive electrolyte storage tank 518. And the method operations can end.

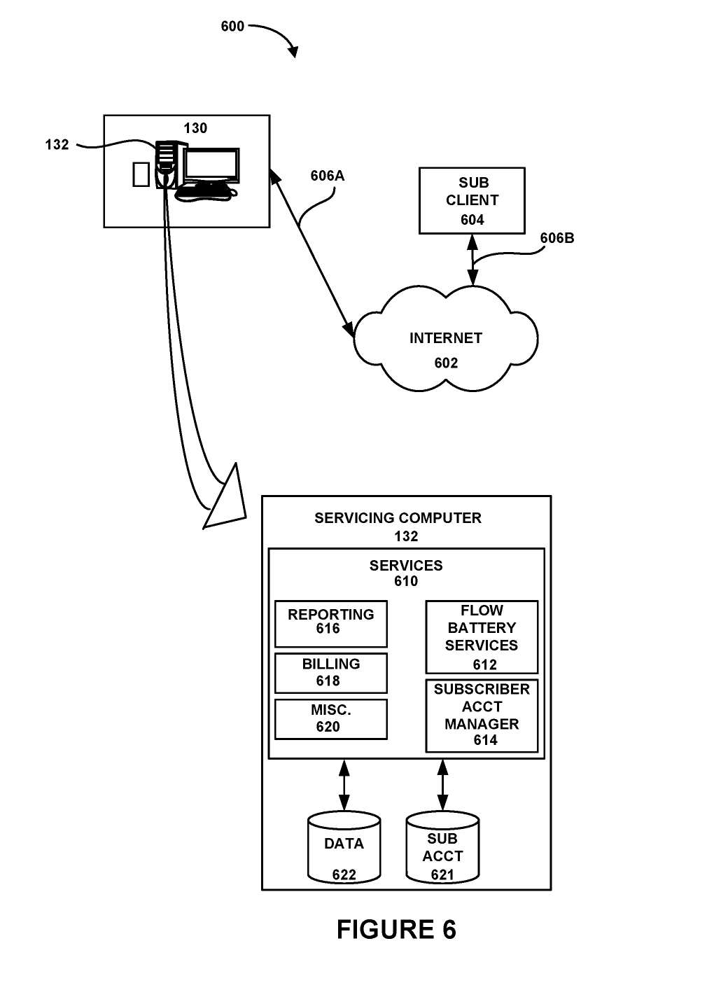

FIG. 6 is simplified block diagram of the flow battery services system 600, for implementing embodiments of the present disclosure. The flow battery services system 600 includes the servicing office 130 that is coupled to the Internet 602 via a first data network 606A and a subscriber's client device 604 coupled to the Internet via a second data network 606B.

The servicing office 130 includes a servicing computer 132 as described in FIG. 1 above. The servicing computer 132 includes various software and hardware applications for providing the flow battery servicing and the subscriber account functions. Some of the software and hardware applications include flow battery services 612, a subscriber account manager 614, a reporting module 616, a billing module 618 and a miscellaneous module 620 for performing many other functions. The servicing computer also includes one or more storage devices for storing servicing operations data 622 and subscriber account information database 621.

A subscriber can use their client device 604 to access their subscriber account information database 621 in the servicing office 130. The subscriber account information database 621 includes the subscriber's account in the corresponding subscriber settings and subscriber account information corresponding to their desired servicing of their flow battery 102.

The flow battery services 612 includes all of the operations relating to the actual servicing of the flow batteries 102 such as record-keeping, report production, flow battery servicing dispatch orders, and more.

The reporting module 616 provides reports of the various servicing operations conducted by the flow battery services 612, the subscriber account manager 614, the billing 618 and miscellaneous module 620. The reports can include failure reporting, maintenance reporting, performance trending data, and many other types of data mining and data reporting, as may be needed. The billing module 618 provides the billing functionality for billing the subscriber for the services under the subscriber account terms.

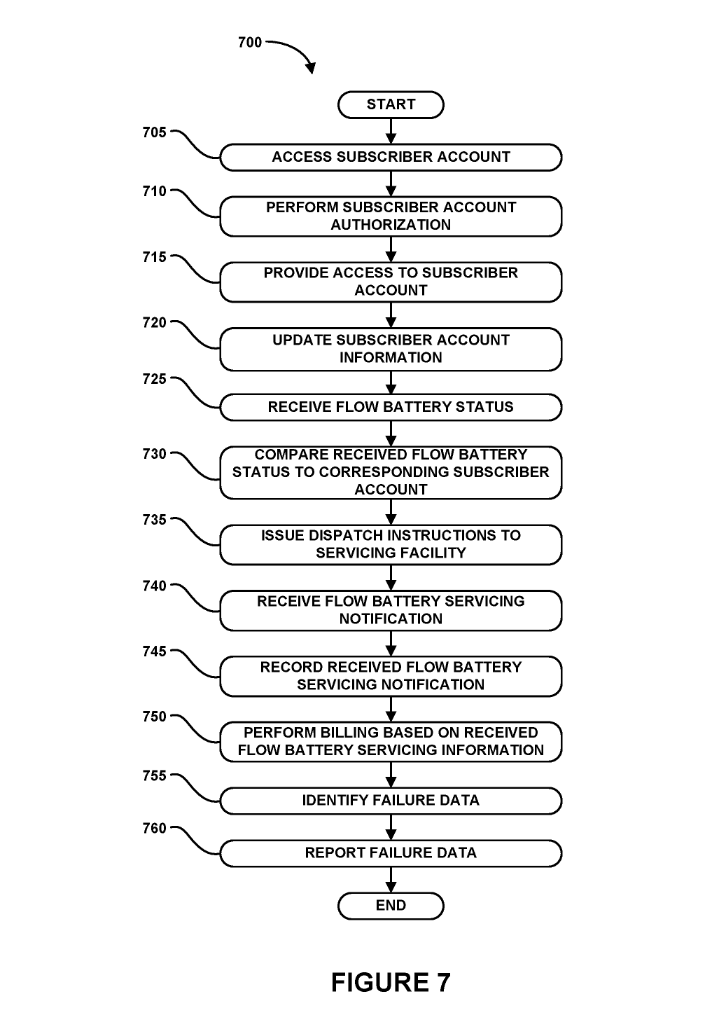

FIG. 7 is a flowchart diagram that illustrates the method operations performed in processing and accessing a subscriber account for servicing a flow battery 700, for implementing embodiments of the present disclosure. The operations illustrated herein are by way of example, as it should be understood that some operations may have sub-operations and in other instances, certain operations described herein may not be included in the illustrated operations. With this in mind, the method and operations 700 will now be described.

In an operation 705, a subscriber accesses the subscriber account manager module 614 with a corresponding subscriber account authorization information, e.g., login information. The subscriber uses the subscriber client device 604 via networks 606A, 606B and the Internet 602 to access the subscriber account manager module 614.

In an operation 710, the subscriber account manager module 614 compares the subscriber account authorization information provided by the subscriber to the subscriber account information database 621 to identify a corresponding subscriber account and the subscriber account information for that subscriber account.

In an operation 715, the subscriber account manager module 614 provides access to the corresponding subscriber account to the subscriber client device 604 when the subscriber account authorization information provided by the subscriber matches a corresponding subscriber account in the subscriber account information database 621.

In an operation 720, the subscriber modifies or updates the corresponding subscriber account information in the subscriber account information database 621. By way of example, the subscriber can update a billing information, or a services level setting that determines the type of servicing provided to the subscribers flow battery 102. Returning to the examples described above, and one implementation, the subscriber can change how often the subscribers flow battery 102 is serviced, or other settings such as how often to query the status of the subscriber's flow battery.

In an operation 725, the flow battery services module 612 receives a status of a flow battery 102. The status includes an identifier for the flow battery 102. The subscriber account manager module 614 compares the identifier of the flow battery received in the status report to identify a corresponding subscriber account in the subscriber account information database 621.

In an operation 730, the flow battery services module 612 compares the received status of the flow battery 102 to the corresponding subscriber account settings to determine if the flow battery is due for service.

In an operation 735, the flow battery services module 612 issues a dispatch instruction to the servicing facility 140 when the received status of the flow battery 102 satisfies the service requirements specified in the corresponding subscriber account settings.

In an operation 740, a servicing facility 140 and/or the flow battery 102, notifies the flow battery services module 612 that the flow battery has been serviced. A detailed report of the servicing that was performed can be included in the servicing notification. By way of example, the quantity of electrolyte 151A and electrolyte 151B that was replaced in the servicing of the flow battery 102 can be included in the detailed report. The detailed report can also include any other servicing issues such as repairs or delays or other information as may be required that occurred during the servicing of the flow battery. By way of example, if the servicing facility 140 discovered that the service port 120 was not operating properly and was in need of repair, and that the servicing facility performed that repair including parts that were replaced and labor that was expended during the repair.

In an operation 745, the received servicing notification can be recorded in the corresponding subscriber account and in the servicing operations data 622. In an operation 750, the billing module 618 receives the servicing notification or other billing initiating event (e.g., periodic billing or power usage based billing or other subscription type billing events or schedules) and performs a corresponding billing function. By way of example, if the servicing of the electrolyte was a routine service included in a servicing agreement corresponding to the subscriber account, then no additional billing may be required. However, if the parts and labor required to perform the repair of the service port 120 was not included in the servicing agreement corresponding to the subscriber account, then the billing module 618 may issue a invoice or otherwise charge a pre-existing charge account corresponding to the subscriber account.

In an operation 755, the reporting module 616 can query the information stored in the data servicing operations 622, to identify a parts failure that was addressed during the servicing of the flow battery 102. By way of example a part of the service port 120 may have failed and required replacement or repair. This failure report can drive an inventory request to replace the parts that were expended in repairing the service port. This failure report can also be used to identify mean time between failures and prepare trending data to identify potential other failures such as other service ports 120 on similarly serviced flow batteries 102.

In an operation 760, the failure reports can be presented to a user either via a display or via a data transfer such as to a manufacturer to order replacement parts and identify failure modes so as to drive improvements in the products. And the method operations can end.

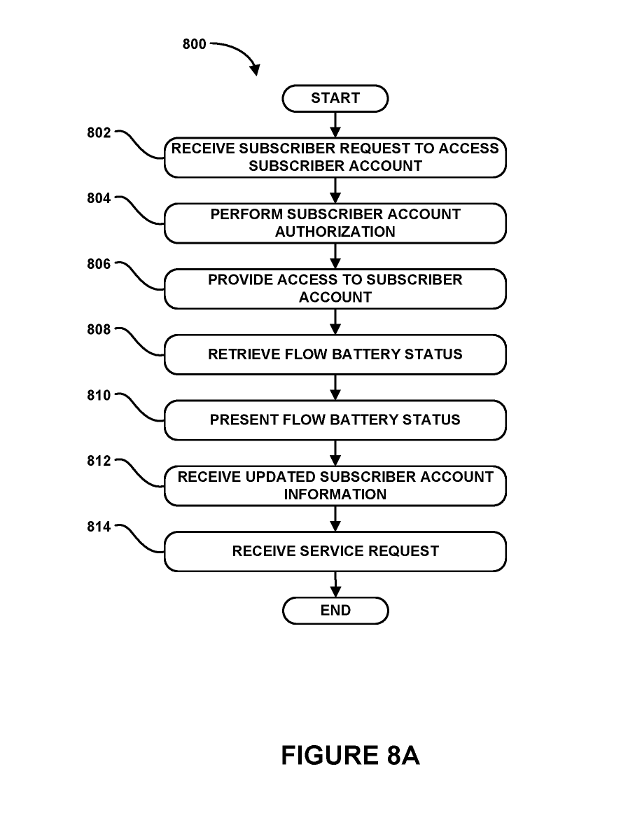

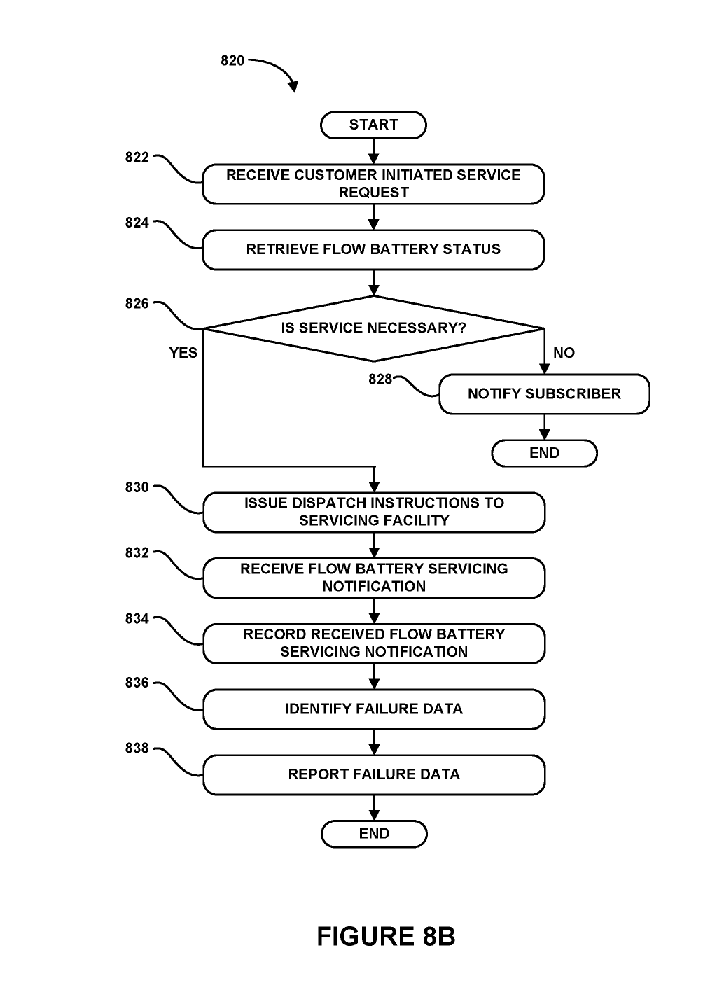

FIG. 8A is a flowchart diagram that illustrates the method operations performed in processing and accessing a subscriber account for servicing a flow battery 800, for implementing embodiments of the present disclosure. The operations illustrated herein are by way of example, as it should be understood that some operations may have sub-operations and in other instances, certain operations described herein may not be included in the illustrated operations. With this in mind, the method and operations 800 will now be described.

In an operation 802, a subscriber request to access the subscriber account is received in the servicing computers 132. In an operation 804, the subscriber account manager module 614 compares the subscriber account authorization information provided by the subscriber to the subscriber account information database 621 to identify a corresponding subscriber account.

In an operation 806, the subscriber account manager module 614 provides access to the corresponding subscriber account to the subscriber client device 604 when the subscriber account authorization information provided by the subscriber matches a corresponding subscriber account in the subscriber account information database 621.

In an operation 808, the flow battery services module 612 receives a status of a flow battery 102. The status includes an identifier for the flow battery 102. The subscriber account manager module 614 compares the identifier of the flow battery received in the status report to identify a corresponding subscriber account in the subscriber account information database 621. The received status of the flow battery 102 can be retrieved from the servicing operations data 622 as the most recently updated flow battery status. Alternatively, the received status of the flow battery 102 can be received directly from the flow battery corresponding to the subscriber account information from the subscriber account information database 621.

In an operation 810, the subscriber account information is output to the subscriber client 604 so that the subscriber can review the flow battery status and other aspects of the subscriber account information.

In operation 812, an update to one or more fields of the subscriber account information can be received in the servicing computer 132 and the updated subscriber account information can be stored in the subscriber account information database 621.

In an operation 814, a service request can be received in the servicing computer 132 and from the subscriber client device 604 corresponding to the subscriber account information. The received service request is processed according to the method operations of FIG. 8B as described below and the method operations can end.

FIG. 8B is a flowchart diagram that illustrates the method operations 820 performed in processing a service request for servicing a flow battery 102, for implementing embodiments of the present disclosure. The operations illustrated herein are by way of example, as it should be understood that some operations may have sub-operations and in other instances, certain operations described herein may not be included in the illustrated operations. With this in mind, the method and operations 820 will now be described.

In an operation 822, a customer initiated service request is received in the servicing computer 132. In an operation 824, the flow battery status corresponding to the customer initiated service request is retrieved. The retrieved flow battery status can be a last reported flow battery status or alternatively can be a response to a status request received from the corresponding flow battery 102.

In an operation 826, retrieved flow battery status is compared to the corresponding subscriber account information to determine if any services on the flow battery 102 are necessary. If no flow battery services are necessary, then a notice is sent to the subscriber in an operation 828 and the method operations can end.

If in operation 826, flow battery services are necessary, then the method operations continue in an operation 830. In operation 830, the flow battery services module 612 issues a dispatch instruction to the servicing facility 140.

In an operation 832, a servicing facility 140 and/or the flow battery 102, notifies the flow battery services module 612 that the flow battery has been serviced. A detailed report of the servicing that was performed can be included in the servicing notification.

In an operation 834, the received servicing notification can be recorded in the corresponding subscriber account and in the servicing operations data 622. In an operation 836, the reporting module 616 can query the information stored in the servicing operations data 622, to identify a parts failure included in the servicing notification. In an operation 838, the failure data can be reported and the method operations can end.

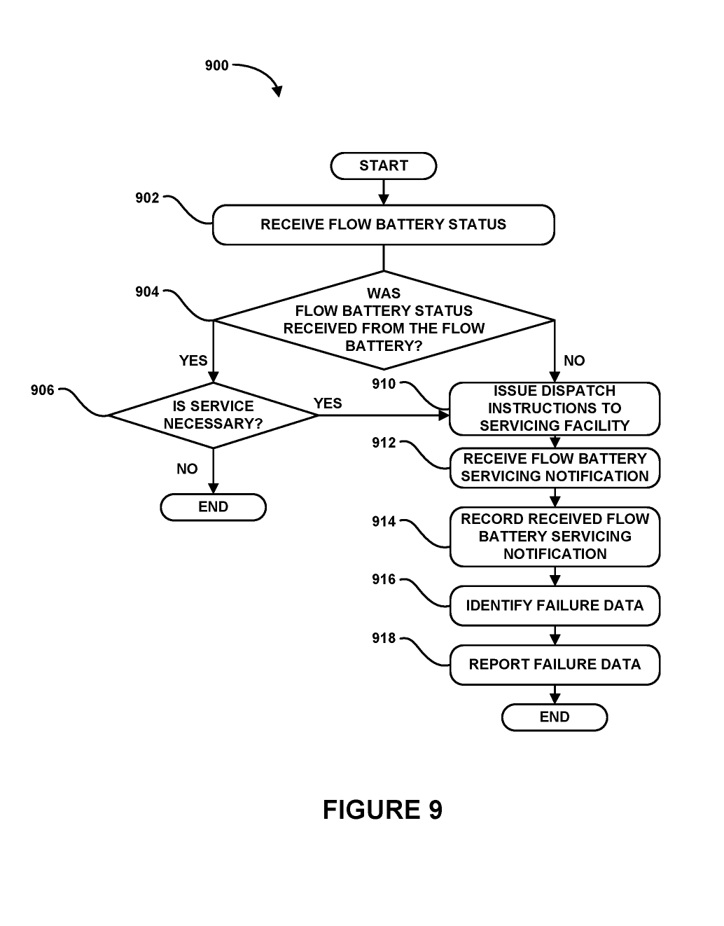

FIG. 9 is a flowchart diagram that illustrates the method operations 900 performed in processing a received flow battery status, for implementing embodiments of the present disclosure. The operations illustrated herein are by way of example, as it should be understood that some operations may have sub-operations and in other instances, certain operations described herein may not be included in the illustrated operations. With this in mind, the method and operations 900 will now be described.

In an operation 902, a flow battery status is received in the servicing office. The flow battery status can be received in the servicing facility from the flow battery in response to a status request from the servicing facility. Alternatively, or additionally, the flow battery status can be automatically sent by the flow battery according to a periodic schedule or when specific set points are achieved, e.g., when specified charge or discharge states or error states occur in the flow battery. If the flow battery status was received from the flow battery 102 in an operation 904, then the method operations continue in an operation 906. If the flow battery status was not received from the flow battery 102, then the method operations continue in an operation 910 as described below.

In operation 906, the corresponding account information settings are compared to the received status of the flow battery to determine if the flow battery is due to be serviced according to the corresponding account information settings. If the flow battery is not due to be serviced according to the corresponding account information settings then the method operations can end. If the flow battery is due to be serviced according to the corresponding account information settings then the method operations continue in operation 910.

In operation 910, the flow battery services module 612 issues a dispatch instruction to the servicing facility 140.

In an operation 912, a servicing facility 140 and/or the flow battery 102, notifies the flow battery services module 612 that the flow battery has been serviced. A detailed report of the servicing that was performed can be included in the servicing notification.

In an operation 914, the received servicing notification can be recorded in the corresponding subscriber account and in the servicing operations data 622. In an operation 916, the reporting module 616 can query the information stored in the servicing operations data 622, to identify a parts failure included in the servicing notification. In an operation 918, the failure data can be reported and the method operations can end.

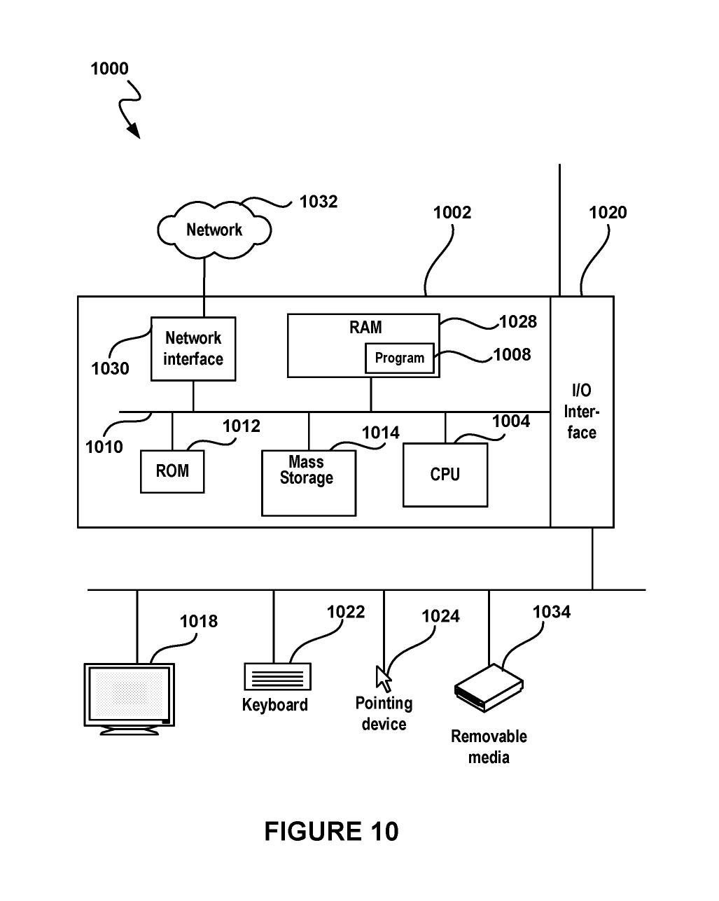

FIG. 10 is a block diagram of an example computer system 1000, for implementing embodiments of the present disclosure. A general or specialized computer system, such as the servicing computers 132 and the controller 123 and used for executing the operations for performing at least a portion of the processes described above such as the servicing computers 132. The computer system 1000 includes a computer 1002, a display 1018, an optional printer or output device (not shown), a removable media (e.g., magnetic/optical/flash) drive 1034, a mass storage system 1014 (e.g., hard disk drive, solid state drive, or other suitable data storage device), a network interface 1030, and a keyboard 1022. Additional user interface devices such as a mouse 1024, a touch pad or touch screen can also be included.

The computer 1002 includes a central processing unit (CPU) 1004, one or more data buses 1010, random access memory (RAM) 1028, read only memory (ROM) 1012, and an input/output interface 1020. The computer 1002 can be a personal computer (such as an IBM compatible personal computer, a Macintosh computer or Macintosh compatible computer), a workstation computer (such as a Sun Microsystems or Hewlett-Packard workstation), or some other suitable type of computer.

The CPU 1004 can be a general purpose digital processor or a specially designed processor. The CPU 1004 controls the operation of the computer system 1000. Using instructions retrieved from memory (e.g. program(s) 1008), the CPU 1004 controls the reception and manipulation of input data and the output and display of data on output devices.

The data buses 1010 are used by the CPU 1004 to access the RAM 1028, the ROM 1012 and the mass storage 1014. The RAM 1028 is used by the CPU 1004 as a general storage area and as scratch-pad memory, and can also be used to store input data and processed data. The RAM 1028 and the ROM 1012 can be used to store computer readable instructions or program code 1008 readable and executable by the CPU 1004 as well as other data.

The bus 1010 can also be used to access the input, output, and storage devices used by the computer 1002. These devices include the display 1018, the optional printer (not shown), the removable media drive 1034, and the network interface 1030. In one implementation, the input/output interface 1020 is used to receive input from keyboard 1022 and send decoded symbols for each pressed key to CPU 1004 over the data bus 1010 and the input/output interface is used to produce output to be presented on the display or outer output device such as a printer (not shown).

The display 1018 is an output device that displays images of data provided by the CPU 1004 via the bus 1010 or provided by other components in the computer system 1000. The optional printer device, when operating as a printer, provides an image on a sheet of paper or a similar surface. Other output devices such as a plotter, projector, etc. can be used in place of, or in addition to, the printer device.

The removable media drive 1034 and the mass storage 1014 can be used to store various types of data. The removable media drive 1034 facilitates transporting such data to other computer systems, and mass storage 1014 permits fast access to large amounts of stored data. The mass storage 1014 may be included within the computer system or may be external to the computer system such as network attached storage or cloud storage accessible over one or more networks (e.g., local area networks, wide area networks, wireless networks, Internet 1032) or combinations of such storage devices and locations.

The CPU 1004 together with an operating system operate to execute computer readable code and logic and produce and use data. The computer code, logic and data may reside within the RAM 1028, the ROM 1012, or the mass storage 1014 or other media storage devices and combinations thereof. The computer code and data could also reside on a removable program medium and loaded or installed onto the computer system 1000 when needed. Removable program media include, for example, DVD, CD-ROM, PC-CARD, floppy disk, flash memory, optical media and magnetic disk or tape.

The network interface 1030 is used to send and receive data over a network 1032 connected to other computer systems. An interface card or similar device and appropriate software implemented by the CPU 1004 can be used to connect the computer system 1000 to an existing network and transfer data according to standard protocols such as local area networks, wide area networks, wireless networks, Internet and any other suitable networks and network protocols.

The keyboard 1022 is used by a user to input commands and other instructions to the computer system 1000. Other types of user input devices can also be used in conjunction with the present invention. For example, pointing devices such as a computer mouse, a track ball, a stylus, touch pad, touch screen or a tablet can be used to manipulate a pointer on a screen of a general-purpose computer.

The disclosure may be practiced with other computer system configurations including hand-held devices, microprocessor systems, microprocessor-based or programmable consumer electronics, minicomputers, mainframe computers and the like. The disclosure may also be practiced in distributing computing environments where tasks are performed by remote processing devices that are linked through a network.

With the above embodiments in mind, it should be understood that the disclosure may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the disclosure are useful machine operations. The disclosure also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data maybe processed by other computers on the network, e.g., a cloud of computing resources.

The embodiments of the present disclosure can also be defined as a machine that transforms data from one state to another state. The transformed data can be saved to storage and then manipulated by a processor. The processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine.

The disclosure can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

The foregoing description is focused on servicing flow batteries as an example of servicing energy storage systems. However, it should be understood that other types of energy storage systems can be serviced in a similar manner Other types of energy storage systems can include other energy storage media such as compressed gas, stored heated media, kinetic energy storage systems and/or wet and/or dry cell- type electrical storage battery or batteries and combinations of two or more of the above energy storage systems.

In a compressed gas energy storage system the compressed gas would be utilized to generate electricity to support the load in much the same way as the flow battery system described above. When the compressed gas storage is depleted, the portable servicing facility 140 can be dispatched to replenish the compressed gas at the point of use. Some examples of replenishing the compressed gas can include delivering additional compressed gas to the point of use such as from a tank of compressed gas on the portable servicing facility 140 or with a compressor to compress air, if the compressed gas is compressed air, or replacing a portion of the depleted compressed gas storage capacity, e.g., pressurized tanks, with compressed gas storage capacity that has a higher compressed state than the depleted compressed gas storage capacity. The portable servicing facility 140 can provide the electrical power for the load while the portable servicing facility is on site to service the compressed gas storage.

In a stored heat energy storage system a heated media would be contained in a suitable storage tank near the point of use, e.g., near the load. The heated media would be utilized to generate electricity to support the load in much the same way as the flow battery system described above. The heated media can be any suitable heated media such as a heated liquid and/or heated solid or a combination of a heated liquid and a heated solid. The heated media may also be pressurized. When the heated media is depleted, e.g., cooled, to a selected level, the portable servicing facility 140 can be dispatched to replenish the heated media at the point of use. Some examples of replenishing the heated media can include replacing the depleted heated media with additional heated media delivered to the point of use or heating the heated media at the point of use. The portable servicing facility 140 can provide the electrical power for the load while the portable servicing facility is on site to service the stored heat energy storage system.

In a kinetic energy storage system a moving mass is contained in a suitable storage tank near the point of use, e.g., near the load. The moving mass would be utilized to generate electricity to support the load in much the same way as the flow battery system described above. The moving mass can be any suitable moving mass such as a flywheel. When the kinetic energy storage is depleted, e.g., slowed, to a selected level, the portable servicing facility 140 can be dispatched to replenish the kinetic energy at the point of use. Some examples of replenishing the kinetic energy can include replacing the moving mass with additional moving mass delivered to the point of use or adding energy, e.g., accelerating, the moving mass at the point of use. The portable servicing facility 140 can provide the electrical power for the load while the portable servicing facility is on site to service the kinetic energy storage system.

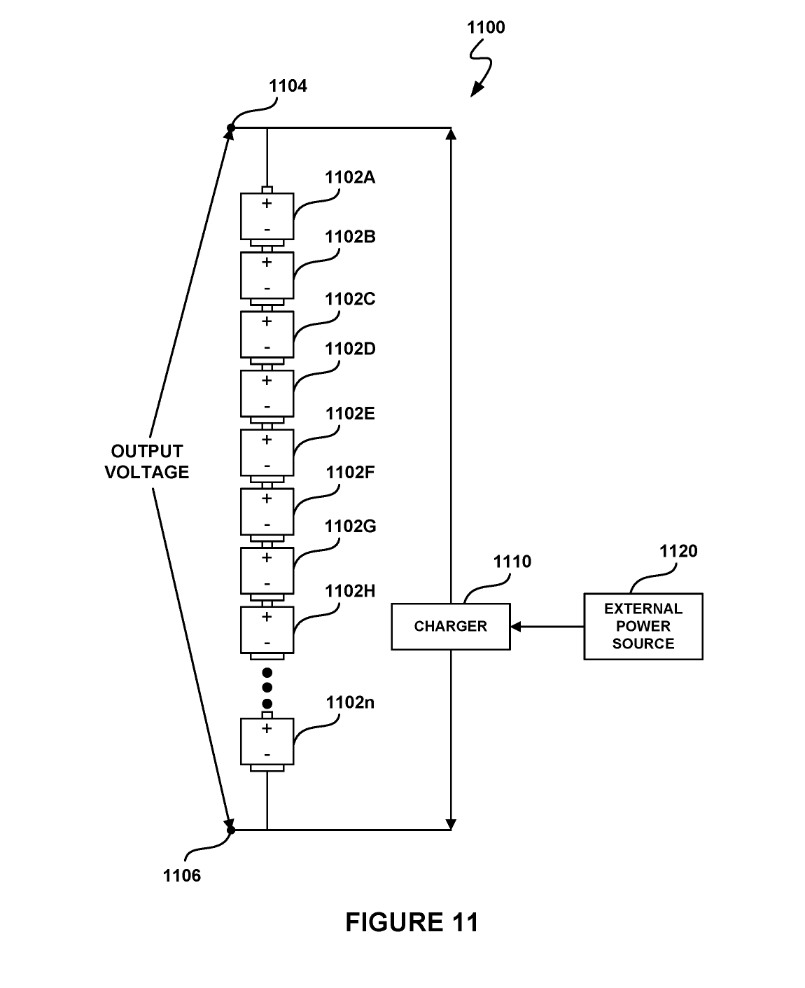

Energy storage systems utilizing wet and/or dry cell-type electrical storage battery or batteries provide many opportunities for the above described servicing and operations. FIG. 11 is a simplified block diagram of an energy storage system 1100, for implementing embodiments of the present disclosure. The energy storage system 1100 includes multiple cells 1102A-n. Each of the multiple cells 1102A-n includes a positive pole and a negative pole. The multiple cells 1102A-n are coupled in series. With a positive output node 1104 coupled to the positive pole of cell 1102A and a negative output node 1106 coupled to the negative pole of cell 1102n. The output voltage is an additive function of the number of cells 1102A-n coupled in series between the positive output node 1104 and the negative output node 1106.

The multiple cells 1102A-n in the energy storage system 1100 are electrically connected by contacts at each of the positive pole and negative pole of each of the multiple cells 1102A-n. In other implementations, the positive pole and negative pole of each of the multiple cells 1102A-n can be coupled together using other suitable electrical coupling methods such as welding, soldering, bolted tie bars.

Each of the multiple cells 1102A-n can be removed from the energy storage system 1100 for maintenance. By way of example, if cell 1102D failed, then the failed cell could be removed and replaced with a replacement cell.

The energy storage system 1100 can optionally include a charger 1110 for recharging the multiple cells 1102A-n. The charger 1110 can be electrically connected to an external power source 1120. It should be understood that the charger 1110 can be detachably connected to the energy storage system 1100 and the external power source 1120, thus allowing the charger to be disconnected from the energy storage system and/or the external power source when not needed to recharge the multiple cells 1102A-n. The forgoing example is a simplified, series type energy storage system 1100 and more complex versions including one or more series and/or parallel electrical current paths can be formed.

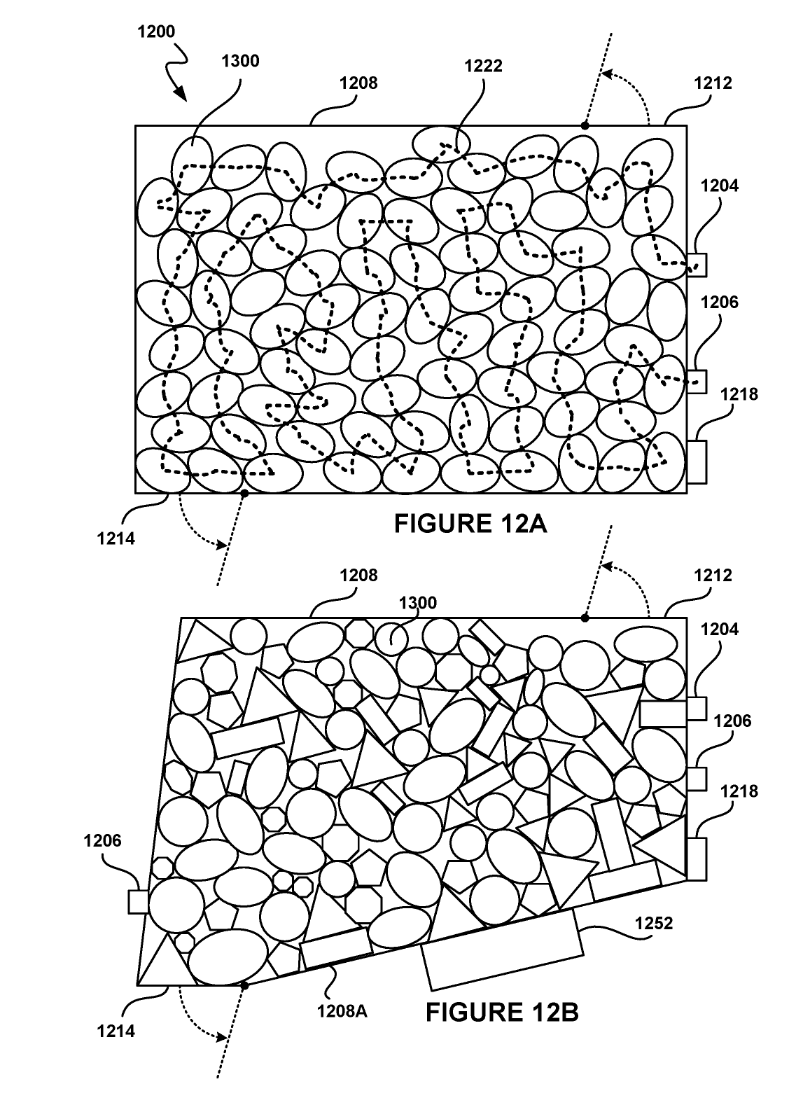

FIG. 12A is simplified block diagram of an energy storage system 1200, using multiple flex cells 1300, for implementing embodiments of the present disclosure. The energy storage system 1200 includes multiple, flex cells 1300 that are contained within a container 1208. The container 1208 is substantially equivalent to the electrolyte reservoirs described above with regard to the flow battery systems. The container 1208 includes fill port 1212 that can be opened and closed as shown by the dashed lines. The container 1208 can optionally include a drain port 1214.

The container 1208 includes a positive node 1204, a negative node 1206, and a controller 1218. It should be noted that the location of the positive node 1204 and the negative node 1206, can be in any particular location as may be selected by the controller 1218, as will be described in more detail below. It should also be understood that the container 1208 can include multiple nodes that can be selected to be the positive node 1204 and the negative node and/or have multiple positive nodes and negative nodes.

The controller 1218 communicates with each of the multiple flex cells 1300 and selects and establishes a current path 1222 providing the desired voltage and current through at least a portion of the flex cells and one or more positive nodes 1204 and one or more negative nodes 1206. The current path 1222 is shown by the dashed line passing through multiple flex cells. It should be noted that a few of the flex cells 1300 are not included in the dashed line 1222. It should also be noted that the dashed line 1222 connected the flex cells 1300 only in series, however as will be described in more detail below parallel electrical connections of the flex cells could also be formed and combinations of series and parallel circuit connections of the flex cells can be formed.

The container 1208 also includes a fill port 1212 and drain port 1214 that can also be opened and closed as shown by the dashed lines. The fill port 1212 and the drain port 1214 allow the multiple flex cells 1300 to be added or removed from the container 1208. Utilizing one or both of the fill port 1212 and the drain port 1214, the portable servicing facility 140 can remove and replace a portion of or all of the multiple flex cells 1300 to or from the container 1208. In one implementation, only one fill or drain port may be included and the flex cells can be added and removed via the single fill or drain port.

In one implementation, the portable servicing facility 140 includes a vacuum type system to withdraw the flex cells 1300 from the container 1208 through either or both of the fill port 1212 and/or the drain port 1214. In another implementation, the portable servicing facility 140 uses a forced media type system to push the flex cells 1300 from the container 1208 through either or both of the fill port 1212 and/or the drain port 1214. The forced media could be forced air or compressed air, in one implementation, that can be used to entrain and transport the flex cells 1300 from the container 1208. In one implementation, the portable servicing facility 140 could use a combination of a vacuum type system to withdraw the flex cells from the container through the drain port 1214 while also applying a forced media to the fill port 1212, thus allowing the portable servicing facility to more rapidly remove the flex cells 1300 from the container 1208.

In another implementation, the portable servicing facility 140 could use a forced media that could be a liquid or other fluid to entrain and transport the flex cells 1300 from the container 1208. Any suitable liquid or fluid that is compatible with the flex cells 1300 could be used. Utilizing a liquid forced media could also allow the container 1208 to be cleaned or otherwise sanitized to improve performance of the energy storage systems 1200, 1250. By way of example, a fluid or liquid could be used to entrain and transport the flex cells 1300 from the container 1208. After the flex cells 1300 are removed from the container 1208, the fluid or liquid could be evacuated or otherwise dried from the interior of the container, thus clearing the interior of the container of any debris or other, undesirable materials that may be present in the container 1208.

As shown in FIG. 12A, each of the multiple flex cells 1300 is substantially uniform in shape and size. FIG. 12B is a simplified block diagram of an energy storage system 1250, using multiple flex cells 1300, for implementing embodiments of the present disclosure. The energy storage system 1250 includes multiple flex cells 1300 having various shapes, sizes and proportions. The varying shapes, sizes and proportions of the multiple flex cells 1300 allows more of the flex cells to fit within the confines of the container 1208.

The container 1208 can optionally include a sloped bottom section 1208A to aid in the removal of the multiple flex cells 1300. The container 1208 can also optionally include a shaker or stirring system 1252 configured for stirring or shaking or otherwise moving the multiple flex cells 1300 within the container. Stirring shaking or otherwise moving the flex cells 1300 within the container 1208 can also aid in increasing the number of flex cells within the container thus increasing the power density of the energy storage systems 1200, 1250.

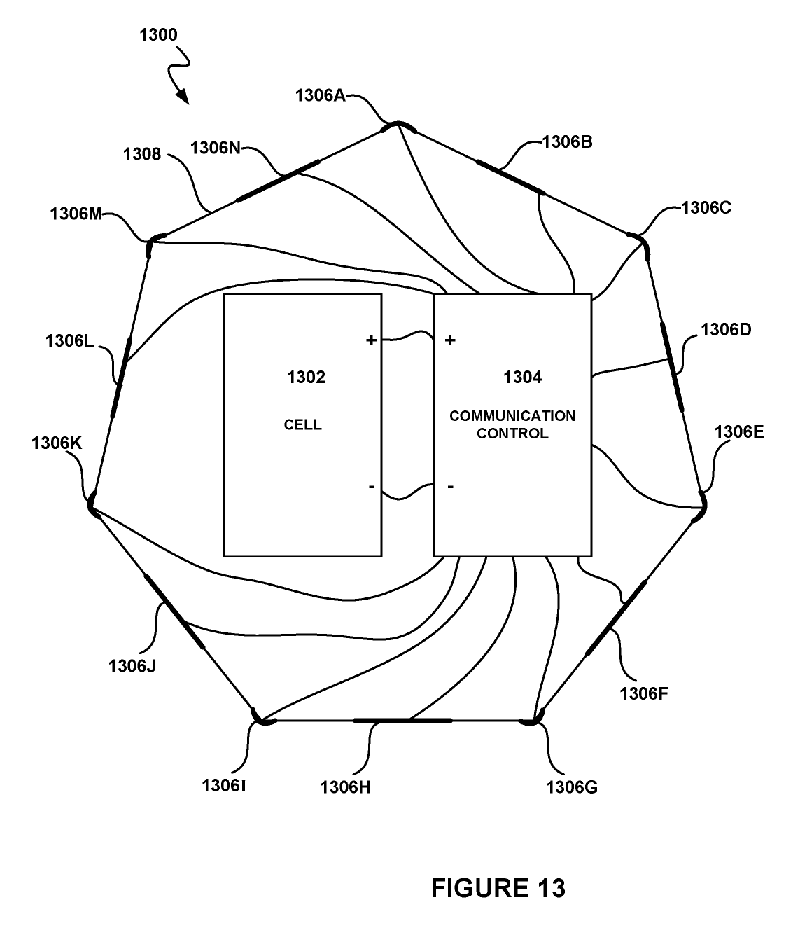

FIG. 13 is a simplified block diagram of a flex cell 1300 configured for use in the energy storage system 1200, for implementing embodiments of the present disclosure. The flex cell 1300 includes an external shell 1308 enclosing a storage cell 1302 and a communication control module 1304. The storage cell 1302 includes a positive node + and a negative node −. The storage cell 1302 is an energy storage cell. Non-limiting examples of energy storage cells include any suitable air, liquid, gel and dry type energy storage cells, capacitors, supercapacitors, lead-acid batteries, lithium ion batteries, nickel cadmium batteries and any other suitable energy storage cells. The positive node + and the negative node − are connected to a respective positive node + and negative node − on the communication control module 1304. The external shell 1308 includes multiple contact pads 1306A-N. Each of the contact pads 1306A-N is individually connected to the communication control module 1304 by respective conductive leads.

In operation, the communication control module 1304 and/or the energy storage system controller 1218 detect one or more adjacent flex cells 1300. The communication control module communicates with the corresponding communication control module in the adjacent flex cells and/or the energy storage system controller 1218 to establish the desired current path 1222 through the multiple flex cells to the positive node 1204 and the negative node 1206 of the energy storage system 1200, 1250. It should be noted that the shape, size and number of contact pads 1306A-N on the external shell 1308 of each of the flex cells can vary by shape and size of the different shapes and sizes of flex cells. The communication control module 1304 and/or the energy storage system controller 1218 assigns and connects the positive + node and negative − node to the selected contact pads 1306A-N on the external shell 1308 of each of the flex cells. By way of example, if a first adjacent flex cell positive node is in contact with contact pad 1306C and a second adjacent flex cell negative node is in contact with contact pad 1306F, then, in a series connection with the adjacent flex cells, the communication control module 1304 and/or the energy storage system controller 1218 connects the positive + node of cell 1302 to the contact pad 1306F and the negative − node of cell 1302 to the contact pad 1306C.

In a similar fashion, the energy storage system controller 1218 can select one or more of the multiple positive nodes and multiple negative nodes of the container 1208 that are in contact with selected flex cells 1300 to establish the desired series and/or parallel circuits through the multiple flex cells. The selected positive node and negative node can then be coupled to the output of the energy storage system.

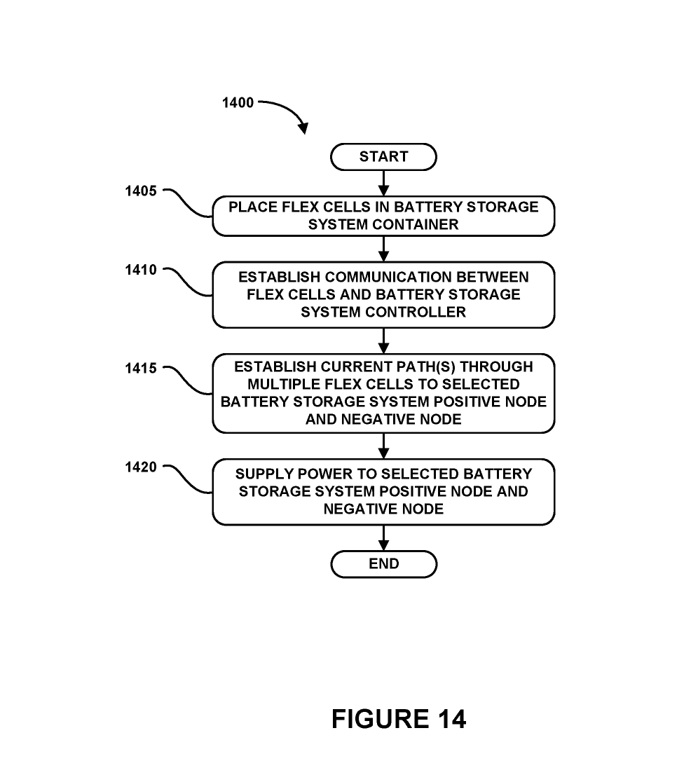

FIG. 14 is a flowchart diagram that illustrates the method operations 1400 performed in operating the energy storage system 1200, 1250 with multiple flex cells 1300, for implementing embodiments of the present disclosure. The operations illustrated herein are by way of example, as it should be understood that some operations may have sub-operations and in other instances, certain operations described herein may not be included in the illustrated operations. With this in mind, the method and operations 1400 will now be described.

In an operation 1405, multiple flex cells 1300 are placed in the energy storage system container 1208. In an operation 1410, each of the flex cells 1300 establish communications with adjacent flex cells and/or communications with the controller. Establishing the communication links with the adjacent flex cells and/or the controller 1218 allows each of the flex cells to identify adjacent flex cells and also identify which contact pads provide electrical connections to the respective contact pads on adjacent flex cells.

In an operation 1415, the electrical connections between the multiple flex cells 1300 are identified and the respective communication control module 1304 in each of the flex cells and/or the controller 1218 determines one or more current paths through the multiple flex cells to the selected energy storage system positive node and negative node to provide the desired current and voltage required of the energy storage system 1200, 1250. By way of example, if there are 500 flex cells 1300 in the energy storage system container 1208, and the output voltage of each of the flex cells is 1.6 volt, and the required output voltage of the energy storage system 1200, 1250 is 200 volts, then the communication control module 1304 in each of the flex cells and/or the controller 1218 can determine up to four separate current paths 1222 through the multiple flex cells. Each of the four separate current paths 1222 can be established through 125 different flex cells and each of the current paths can have a voltage of 200 volts. The four separate current paths 1222 can then be coupled in parallel at the output nodes 1204, 1206 of the energy storage system 1200, 1250.

In an operation 1420, the energy storage system 1200, 1250 provides power via the output nodes 1204, 1206 to an electrical load, such as the loads described above. And the method operations can end.

Eventually, the multiple flex cells 1300 will become depleted and unable to support the electrical power draw demanded by the load coupled to the output nodes 1204, 1206. In one implementation, a local power source such as a solar panel 105, in combination with the recharging device 106, as described in FIG. 1 above, can be utilized to recharge the multiple flex cells in much the same way any electrical storage cell can be recharged. However, just as the flow battery described in the above figures may need servicing the energy storage system 1200, 1250 may also need servicing.

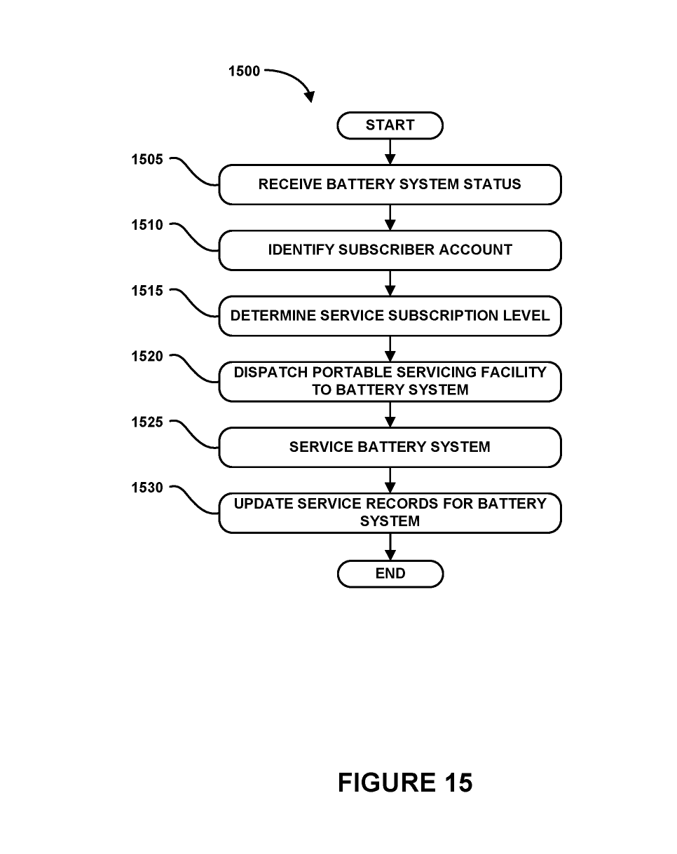

FIG. 15 is a flowchart diagram that illustrates the method operations 1500 performed in servicing the energy storage system 1200, 1250 with multiple flex cells 1300, for implementing embodiments of the present disclosure. The operations illustrated herein are by way of example, as it should be understood that some operations may have sub-operations and in other instances, certain operations described herein may not be included in the illustrated operations. With this in mind, the method and operations 1500 will now be described.

In operation 1505, the servicing office 130 receives a servicing request and/or a present status of the energy storage system 1200, 1250. This received request can be manually generated by a subscriber or could be automatically generated by the communications device 122 that is coupled to the energy storage system 1200, 1250.

In an operation 1510, the subscriber account corresponding to the received servicing request or the energy storage system 1200, 1250 is identified. Identifying the subscriber account allows the servicing office 130 to determine what servicing action may be necessary or even allowed according to the subscriber account.

In operation 1515, the servicing office examines the subscriber account to identify the subscription level that can then be used to identify the servicing that is allowed or subscribed for the energy storage system 1200, 1250. Once the servicing that is allowed is identified, then the present status of the energy storage system can be used to determine what services are appropriate. By way of example, if the subscription term specified that any time the flex cells 1300 were depleted to less than 40 percent capacity, then the portable servicing facility 140 should be dispatched to replenish the flex cells. If the present status of the energy storage system 1200, 1250 was that the flex cells were depleted to 22 percent of capacity, then in an operation 1520, the portable servicing facility 140 is dispatched to replenish the flex cells.

In an operation 1525, the portable servicing facility 140 arrives on site of the energy storage system 1200, 1250, and using the servicing coupler 148, couples to the energy storage system and removes at least a portion of the depleted flex cells 1300 and replaces the depleted portion of the flex cells with charged flex cells, such that the energy storage system is sufficiently recharged. The servicing records for the energy storage system can be updated in an optional operation 1530 and the method operations can end.

Although the foregoing disclosure has been described in some detail for purposes of clarity of understanding, it will be apparent that certain changes and modifications may be practiced within the scope of the appended claims. Accordingly, the present embodiments are to be considered as illustrative and not restrictive, and the disclosure is not to be limited to the details given herein, but may be modified within the scope and equivalents of the appended claims.

1. An energy storage servicing system comprising:
a servicing office including a servicing office communication link;
an energy storage system disposed proximate to and electrically coupled to an electrical load, the energy storage system including;
a first quantity of an energy storage media in a first container; and
a communication device for communicating a servicing request to the servicing office via the servicing office communication link, wherein the servicing office includes a servicing computer including:
a subscriber account information database including a subscriber account corresponding to the energy storage system, the subscriber account information database including a plurality of subscriber settings;
a comparer for comparing the servicing request to the plurality of subscriber settings; and
a dispatch instruction issuer for dispatching a portable servicing facility to service the energy storage system, when a selected one or more of the plurality of subscriber settings is satisfied by the service request;
a servicing port coupled to the energy storage system; and
a portable servicing facility including:
a first tank including a second quantity of the energy storage media;
a servicing facility communication link for communicating with the servicing office via the servicing office communication link; and
a servicing coupler coupled to the first tank in the portable servicing facility, the servicing coupler for coupling to the servicing port;
wherein the servicing port includes an electrical supply port and wherein the servicing coupler includes an electrical supply connector coupled to an electrical supply included in the portable servicing facility, the electrical supply connector corresponding to the electrical supply port in the servicing port, wherein the electrical supply included in the portable servicing facility supports an entire electrical power demand for the electrical load when the electrical supply connector is coupled to the electrical supply port and the electrical load is electrically decoupled from the energy storage system when the electrical supply connector is coupled to the electrical supply port.

2. The system of claim 1, wherein the servicing port coupled to the energy storage system includes at least one port coupled to the container and wherein servicing coupler includes at least one port connector corresponding to the at least one port in the servicing port.

3. The system of claim 1, wherein the servicing port coupled to the energy storage system includes a communication port and wherein servicing coupler includes a servicing communication port corresponding to the communication port in the servicing port.

4. The system of claim 1, wherein the selected one or more of the plurality of subscriber settings is satisfied by the service request consists of how often the subscriber selected the energy storage system is to be serviced.

5. The system of claim 1, wherein the container of the energy storage system includes at least one of a fill port or a drain port;
wherein the servicing port includes at least one of a drain port coupled to the container drain port or a fill port coupled to the container fill port; and
wherein the portable servicing facility includes a second tank, wherein the servicing coupler includes at least one of a drain port connector corresponding to the drain port in the servicing port or a fill port connector corresponding to the fill port in the servicing port.

6. The system of claim 1, wherein servicing port and the servicing coupler include one or more alignment structures to provide a corresponding alignment between the servicing port and the servicing coupler.

7. The system of claim 1, wherein the first quantity of the energy storage media includes a first plurality of flex cells and the second quantity of the energy storage media includes a second plurality of flex cells.

8. The system of claim 7, wherein each one of the first plurality of flex cells and the second plurality of flex cells includes:
an external shell;
an energy storage cell disposed within the external shell, the energy storage cell including a positive node and a negative node;
a communication control module disposed within the external shell, the communication control module coupled to the positive node and the negative node of the energy storage cell; and
a plurality of contact pads disposed on an exterior surface of the external shell, each one of the plurality of contact pads electrically connected to the communication control module.

9. The system of claim 8, wherein the communication control module is configured to:
connect a first one of the plurality of contact pads to the positive node of the energy storage cell; and
connect a second one of the plurality of contact pads to the negative node of the energy storage cell.

10. An energy storage system comprising:
a plurality of flex cells in a container, the container including at least one of a container fill port or a container drain port, wherein the flex cells have more than one shape or size;
an energy storage system controller for controlling the energy storage system; and
a servicing port coupled to the energy storage system, the servicing port including:
at least one of a first drain port or a first fill port coupled to a respective at least one of the container drain port or the container fill port;
a communication port coupled to the energy storage system controller; and
an electrical supply port, wherein a portable servicing facility bypasses the energy storage system to support an entire electrical power demand for an electrical load when the portable servicing facility is coupled to the electrical supply port.

11. The energy storage system of claim 10, further comprising a communication device for communicating with a servicing office via a servicing office communication link, wherein the servicing office includes a servicing computer including:
a subscriber account information database including a subscriber account corresponding to the energy storage system, the subscriber account information database including a plurality of subscriber settings;
a comparer for comparing the servicing request to the plurality of subscriber settings; and
a dispatch instruction issuer for dispatching a portable servicing facility to service the energy storage system, when a selected one or more of the plurality of subscriber settings is satisfied by the service request.

12. A method of servicing an energy storage system comprising:
receiving an energy storage system status in a servicing computer for a servicing office via a servicing office communication link, the servicing computer including a subscriber account information database including a subscriber account corresponding to the energy storage system, the subscriber account information database including a plurality of subscriber settings;
determining if an energy storage system servicing is needed including:
comparing the servicing request to the plurality of subscriber settings in a comparer in the servicing computer;
dispatching a portable servicing facility to the energy storage system, when a selected one or more of the plurality of subscriber settings is satisfied by the service request;
coupling the portable servicing facility to a servicing port of the energy storage system including bypassing the energy storage system to support an entire electrical power demand for an electrical load when the portable servicing facility is coupled to the electrical supply port;
servicing the energy storage system; and
disconnecting the portable servicing facility from the servicing port including electrically coupling the energy storage system to support the entire electrical power demand for the electrical load when the portable servicing facility is disconnected from the servicing port.

13. The method of claim 12, wherein servicing the energy storage system includes:
removing a first quantity of energy storage media from the energy storage system wherein the removed first quantity of energy storage media is loaded on the portable servicing facility; and
replacing the removed first quantity of energy storage media with a second quantity of energy storage media.

14. The method of claim 12, wherein the selected one or more of the plurality of subscriber settings is satisfied by the service request consists of how often the subscriber selected the energy storage system is to be serviced.

15. The method of claim 12, wherein the selected one or more of the plurality of subscriber settings is satisfied by the service request consists a selected percentage discharge state of the energy storage system before the energy storage system is to be serviced.

16. The method of claim 12, wherein the energy storage system includes a communication device for communicating with the servicing office via a servicing office communication link.

17. The method of claim 16, wherein the energy storage system status was received by the servicing office in response to a status request sent by the servicing office to the energy storage system via the servicing office communication link.

18. (canceled)

19. (canceled)

20. The method of claim 12, further comprising recharging the portable servicing facility.

21. The method of claim 13, further comprising:
removing the first quantity of energy storage media from the portable servicing facility and placing the first quantity of energy storage media in a support facility; and
reloading a recharged third quantity of energy storage media on the portable servicing facility.

22. The method of claim 21, further comprising recharging the first quantity of energy storage media.

23. The method of claim 22, wherein the third quantity of energy storage media includes at least a portion of the recharged first quantity of energy storage media.

24. The method of claim 12, further comprising updating a status of the energy storage system in the servicing office.

25. The method of claim 24, wherein updating the status of the energy storage system in the servicing office includes initiating a billing cycle to bill a subscriber.

26. The method of claim 24, wherein updating the status of the energy storage system in the servicing office includes performing a servicing analysis.

27. The method of claim 26, wherein the updated status of the energy storage system includes identification of a failure and wherein the servicing analysis includes a failure analysis of the failure.

28. The method of claim 26, wherein the servicing analysis identifies a failed part.

29. The method of claim 26, wherein the servicing analysis includes identifying a quantity of energy storage media removed from the energy storage system.

30. The method of claim 24, wherein updating the status of the energy storage system in the servicing office includes storing the status of the energy storage system in at least one of a subscriber account information database or a servicing operations data.

31. The method of claim 13 claim 12, wherein the first quantity of energy storage media is equal to the second quantity of energy storage media.

32. The method of claim 13, wherein the first quantity of energy storage media is depleted.

33. The method of claim 13, wherein coupling the portable servicing facility to the servicing port of the energy storage system includes deactivating the energy storage system and wherein replacing the first quantity of energy storage media with the second quantity of energy storage media includes reactivating the energy storage system.
